(19) United States
(12) Patent Application Publication
(10) Pub. No.: US 2022/0377070 A1
(43) Pub. Date: Nov. 24, 2022

(54) SYSTEMS AND METHODS FOR TRANSACTION MANAGEMENT IN A CLOUDLESS INFRASTRUCTURE OF COMPUTING DEVICES

(71) Applicants: Jose Roberto Rosas Bustos, Halifax (CA); Joelle Berdugo-Adler, Halifax (CA)

(72) Inventors: Jose Roberto Rosas Bustos, Halifax (CA); Joelle Berdugo-Adler, Halifax (CA)

(21) Appl. No.: 17/750,164

(22) Filed: May 20, 2022

Related U.S. Application Data
(60) Provisional application No. 63/191,228, filed on May 20, 2021.

(51) Int. Cl. H04L 9/40

(52) U.S. Cl. CPC H04L 63/0876

(57) ABSTRACT

A cloudless infrastructure supporting a transaction management service is provided to facilitate asset transactions within the infrastructure. The transaction management service may manage an exchange of assets between entities utilizing the computing devices of the infrastructure in a secure and efficient manner. Such assets may include physical assets, digital assets, and/or a combination of both physical and digital assets, also known as a hybrid asset. Exchanging of assets may include a recursive function for converting an initial asset type into another asset type to facilitate a transaction between entities. Exchange of assets over the infrastructure may include converting one type of asset to another, lending assets for a particular time, renting assets, and/or selling assets so as to convert the initial asset into another infrastructure-supported asset. In some instances, a market of assets may be hosted by the cloudless infrastructure for exchanging or converting assets using the recursive function.

### CROSS-REFERENCE TO RELATED APPLICATION

This application is related to and claims priority under 35 U.S.C. § 119 from U.S. Provisional Application No. 63/191,228 entitled “Systems and Methods for Transaction Management in a Cloudless Infrastructure of Computing Devices,” filed on May 20, 2021, the entire contents of which are fully incorporated by reference herein for all purposes.

### TECHNICAL FIELD

Embodiments of the present invention generally relate to systems and methods for generating and operating an infrastructure of computing devices, and more specifically for managing transactions, including asset transaction, in the infrastructure of computing devices or nodes.

### BACKGROUND

Computing devices connected to or otherwise in communication with a network may receive services from and over the network. The services are many and include communication with and between devices, network computing, cloud services (such as storage services, networking services, and compute services), connection to the public Internet, and the like. To provide such services, cloud providers will often utilize the collective resources of an interconnected group of computing devices. Alternatively or additionally, an Internet Service Provider (ISP) network may provide access to the Internet to a customer device connected to the ISP. The ISP may therefore manage devices and information to provide the Internet access service, which typically involves a database of account information, a domain name system for resolving IP address requests, routers and switches for routing communications from the customer devices, and the like. To reach various services, some network communications will traverse network paths of other providers. In smaller networks, such as local enterprise networks for a business or home, all communications into and out of the network may pass through a single computing device, such as a server, which may also operate as the sole device for network applications and data storage.

Centralized networks offer ease of use and efficiency in maintaining and operating the network. Network devices may be updated regularly through or from a centralized authority, security may be maintained by limiting the accessibility of the network devices to a small number of administrators, and collection and processing of operational data may be simplified through monitoring of a few devices. However, centralized networks have some downsides. For example, centralized networks in which computing devices connect to a central device or device may be vulnerable to a failure at the central device leading to interruption of services for the connected devices. Further, it is sometimes difficult to scale network resources of a small, centralized network to meet customer demand, as scaling generally requires the addition and provisioning of new equipment within the network. Also, use of a centralized network to access the Internet may require customer devices to provide personal information of users, such as passwords, search history, banking information, and the like, during interactions with websites, all of which may be stored in devices within the centralized network. For these and many other reasons, centralized networks of a single controlling device or authority, while ubiquitous, have various drawbacks when providing network services.

It is with these observations in mind, among other, that aspects of the present disclosure were conceived.

### SUMMARY

One aspect of the present disclosure relates to a method for transaction management in a cloudless infrastructure. The method may include the operations of obtaining, via an asset management service hosted on an infrastructure of computing devices, an initial asset associated with a device identifier of a device in communication with the infrastructure, recursively converting, based on one or more infrastructure performance parameters associated with converting the initial asset to a plurality of other assets, the initial asset to a secondary asset, and providing access to the secondary asset to a receiving device in communication with the infrastructure.

Another aspect of the present disclosure relates to a method for asset management in a cloudless infrastructure. The method may include the operation of storing, via an asset management service hosted on an infrastructure of computing devices, an identifier of a physical component and an identifier of a software component of a dynamic hybrid asset, the software component executable only by the physical component based on an authentication of the identifier of the software component and the identifier of the physical component, the dynamic hybrid asset configurable in response to a detected change in a physical condition associated with the dynamic hybrid asset.

Another aspect of the present disclosure relates to a cloudless infrastructure of interconnected computing devices. The infrastructure may include a plurality of node devices. A first of the plurality of node devices may include a processor and a non-transitory computer-readable medium storing instructions that, when executed, cause the processor of the first of the plurality of node devices to execute one or more operations. Such operations may include obtaining, via an asset management service hosted on the infrastructure, an initial asset associated with a device identifier of a device in communication with the first of the plurality of node devices, recursively converting, based on one or more infrastructure performance parameters associated with converting the initial asset to a plurality of other assets, the initial asset to a secondary asset, and providing access to the secondary asset to a receiving device in communication with the infrastructure.

Still another aspect of the present disclosure relates to a system for asset management in a cloudless infrastructure. The system may comprise a node device comprising a processor and a non-transitory computer-readable medium storing instructions that, when executed, cause the processor of the node device to store, via an asset management service hosted on an infrastructure of computing devices, an identifier of a physical component and an identifier of a software component of a dynamic hybrid asset, the software component executable only by the physical component based on an authentication of the identifier of the software component and the identifier of the physical component, the dynamic hybrid asset configurable in response to a detected change in a physical condition associated with the dynamic hybrid asset.

### BRIEF DESCRIPTION OF THE DRAWINGS

The foregoing and other objects, features, and advantages of the present disclosure set forth herein should be apparent from the following description of particular embodiments of those inventive concepts, as illustrated in the accompanying drawings. The drawings depict only typical embodiments of the present disclosure and, therefore, are not to be considered limiting in scope.

FIG. 1 is a schematic diagram illustrating an exemplary infrastructure of computing devices in accordance with one embodiment.

FIG. 2 is a schematic diagram illustrating a node device for connecting to a cloudless infrastructure of computing devices in accordance with one embodiment.

FIG. 3 is a flowchart illustrating one method for generating a device identifier for a computing device communicating with a cloudless infrastructure in accordance with one embodiment.

FIG. 4 is a schematic diagram illustrating an exemplary operating environment for providing secure interactions with a cloudless infrastructure in accordance with one embodiment.

FIG. 5 is a flowchart illustrating one method for generating encryption keys for a computing device associated with a cloudless infrastructure in accordance with one embodiment.

FIGS. 6A and 6B illustrate distribution of resources among nodes of a cloudless infrastructure based on a density value of node resources in accordance with one embodiment.

FIG. 7 is a flowchart of a method for managing a transaction over a cloudless infrastructure of computing devices in accordance with one embodiment.

FIG. 8 is a flowchart of a recursive method for managing an asset transaction on a cloudless infrastructure of computing devices in accordance with one embodiment.

FIG. 9 is a flowchart of a method for optimizing a transfer of assets in a cloudless infrastructure of computing devices in accordance with one embodiment.

FIG. 10 is a schematic diagram illustrating a hybrid asset that includes a physical component and a software component in accordance with one embodiment.

FIG. 11 is a flowchart of a method for altering a characteristic of a hybrid asset based on one or more preferences and detected conditions in accordance with one embodiment.

FIG. 12 is a flowchart of a method for associating a hybrid asset with one or more identifiers managed by a cloudless infrastructure of computing devices in accordance with one embodiment.

FIG. 13 is a diagram illustrating an example of a computing system which may be used in implementing embodiments of the present disclosure.

### DETAILED DESCRIPTION

Aspects of the present disclosure involve an apparatus, device, systems, methods, and the like, for instantiating and operating an infrastructure of computing devices, also referred to as nodes of the infrastructure. In one implementation, a cloudless infrastructure may comprise a collection of computing devices that communicate peer-to-peer and mostly off-grid (or otherwise without communicating through a conventional centralized network) to share resources, access, and provide services and applications, store and access data and other information, and the like. The systems described herein may provide services to connecting computing devices, such as user devices, personal computing devices, mobile devices, laptops, personal computers, Internet of Things (IoT) devices etc., in communication with one or more of the nodes of the infrastructure. Through the computing devices and the various techniques discussed herein, the system generates an infrastructure to exchange or manage communications, transactions, and/or data in a cloudless and/or decentralized manner or otherwise to freely exchange information between the nodes to allow the infrastructure to scale in response to client demands, adapt the infrastructure to a failed node with minimal impact on connected computing devices, and provide robust security to customer information, communications, and devices.

In one implementation of the infrastructure, the node devices of the infrastructure may collectively operate a network of interconnected and communicating devices. Further, as the communications between the devices of the infrastructure may occur in a direct, peer-to-peer manner, the infrastructure may be referred to as a cloudless network of devices. As such, the infrastructure may be referred to herein as a “cloudless network”. However, it should be appreciated that the infrastructure of devices may, in some instances, include supplemental cloud-based communications and/or services, particularly when the cloudless network is not fully deployed, and may provide additional services other than network services, despite being referred to herein as a cloudless network. Other advantages of the infrastructure of devices are discussed with detail below.

In one implementation, the infrastructure may comprise computing devices constructed and/or configured to communicate with other node devices of the infrastructure, the collection of which may form a cloudless network. The node devices may also be configured as gateway devices to communicate with one or more connecting computing devices, such as enterprise computers, network devices, storage devices, mobile phones, laptops, tablets, media players, etc., to provide access to the collection of nodes of the network for the computing devices. As used herein, such connecting computing devices may be referred to as “personal computing devices”, although any type of computing device, networking device, and storage device, including public or private computing devices, may be considered personal computing devices for connecting to the infrastructure to receive or otherwise consume services from the network of devices and for accessing the nodes of the infrastructure. The node devices of the infrastructure may execute one or more software programs to provide services to the personal computing devices, such as compute services, networking services, storage services, multimedia services, and the like, and may otherwise operate as “nodes” of the infrastructure. In general, a node device of the infrastructure may include any computing device connected to or otherwise in communication with another computing device of the cloudless infrastructure. As such, the term “node” used herein may refer to gateway devices, personal computing devices or other connected devices, or any other type of computing device not listed herein but connected to or integrated within the infrastructure. A personal computing device may thus be a node and vice versa. Further, the infrastructure of the nodes may be referred to herein as the decentralized network, the cloudless network, the cloudless, decentralized network, or the network, and such terminology may be considered interchangeable. The nodes of the infrastructure may communicate to share resources to provide such services, such as sharing storage capacity between multiple nodes associated with a provided service. One or more applications may be executed on the nodes of the infrastructure, including the connected computing devices, that utilize aspects of the available services. In this manner, a cloudless infrastructure may be established to provide services to connecting devices.

In one particular implementation, the cloudless infrastructure may provide a transaction management service that, in some instances, utilizes various other services provided by the infrastructure to support or facilitate asset transactions within the infrastructure. For example, one or more nodes of the cloudless infrastructure may include an asset management service or digital “wallet” to manage assets associated with a device or user of the infrastructure or a device in communication with the infrastructure. The transaction management service may utilize one or more secure identifiers associated with a device of or in communication with the infrastructure and/or one or more secure identifiers associated with a user or entity. In general, the transaction management service may manage an exchange of assets between entities utilizing the computing devices or “nodes” of the infrastructure in a secure and efficient manner. Such assets may include physical assets, digital assets, and/or a combination of both physical and digital assets, referred to herein as a “hybrid asset”. The transaction management service of the cloudless infrastructure may, in some instances, execute a recursive function for converting an initial asset type into another asset type to facilitate a transaction between entities. Exchange of assets may occur over the infrastructure and may include communication(s) with third-party entities or systems to facilitate the transaction. In addition, exchange of assets over the infrastructure may include lending assets for a particular time, renting assets, and/or selling assets so as to convert the initial asset into another infrastructure-supported asset. In some instances, a market of assets may be hosted by the cloudless infrastructure for exchanging or converting assets using the recursive function. The market may similarly be managed by the transaction management service available from any number of devices of the cloudless infrastructure.

In some implementations, the recursive function for converting an initial asset type into another asset type to facilitate a transaction between entities may also include an optimization technique for determining an initial asset type and/or an exchanged asset type to use in the transaction. The optimization technique may determine or obtain one or more transaction parameters of asset types to determine an asset exchange with optimized parameters. Such transaction parameters of asset types may include, but are not limited to, a time to process a transaction or exchange, an amount of energy consumed to complete the transaction, infrastructure resource consumption for the transaction (such as compute resources, storage resources, and networking resources used for the transaction), a proximity of infrastructure devices to the requesting device to reduce time for transmission between devices, monetary cost and fees associated with the transaction, and the like. Other transaction parameters may also be obtained and considered during the optimization technique, as explained in more detail below.

To support the transaction management service, an identification service may be executed on the nodes of the cloudless network to generate a unique computing device identifier from the device fingerprint information and register the computing device with the network based on the unique computing device identifier. Further, the new device may interact with the nodes, services, and applications of the network using its unique computing device identifier without the need to store or transmit information of the user, if the computing device is a personal computing device for example, or other information. For example, applications and/or services may be configured to use the unique computing device identifier of the personal computing device as a signature or other identifier in place of a user identifier. Because the device identifier is generated from device-specific information of the personal computing device, it is implicitly tied to a user but personal information of users of the network may not be obtained and stored such that personal information of the user is not shared or put at risk while interacting with the network. In this manner, the identifier used within the cloudless network may be more secure than other types of user identifiers that typically include some personal information of the user that provides for protection of user personal information in an off-grid network like the one described herein.

The cloudless infrastructure may also provide additional unique security features. For example, one or more nodes of the network and/or one or more personal computing devices in communication with the network may generate an encryption key pair for use in encrypting data or information associated with the network. In one instance, the encryption key pair may be generated based on entropic or random information or data obtained from nodes of the network. For example, one or more nodes of the cloudless network may include sensors configured to obtain a measurement of an aspect of the environment around the node. Such measurements may include, but are not limited to, a temperature, humidity, atmospheric pressure, light, and/or sound measurements from the environment around the node device. In another example, one or more bio-measurements associated with a user of a personal device, such as but not limited to, a pulse, an estimated calories burned, a number of steps taken in a time period, etc., may be obtained and transmitted to the node. In general, any type of data or measurements may be obtained or generated by the nodes of network and combined to generate a truly random or entropic set of data. Further, the use of sensors to generate the encryption may consume less energy than other types of encryption generation, such as the energy consume to mine digital currencies and the like.

The node or nodes of the network may utilize the obtained entropic digital data to generate one or more encryption keys for use in encrypting information and/or data associated with the network, including personal transactions conducted on the cloudless network. Because the inputs to generate the encryption keys are randomized as obtained from a random collection of environmental data, physical measurements, bio-information, and other types of randomized data collections from a variety of locations/devices, the generation of encryption keys is far more secure when compared to conventional encryption systems. Further, the encryption keys for the network may be re-generated at an accelerated rate over traditional encryption key rotation cycles as the data from which the keys are generated is randomized and entropic, increasing the secure nature of the encryption service provided by the network. Further still, as additional nodes are registered or added to the network, additional sources of entropic data may be included in the entropic data collection to provide exponential entropic data to the encryption key generation system. Conventional entropic data generation systems typically use one source of data such that the network discussed herein provides an exponentially stronger entropic nature of the collected data for generation of the encryption keys for the network.

Infrastructure of the Cloudless Network

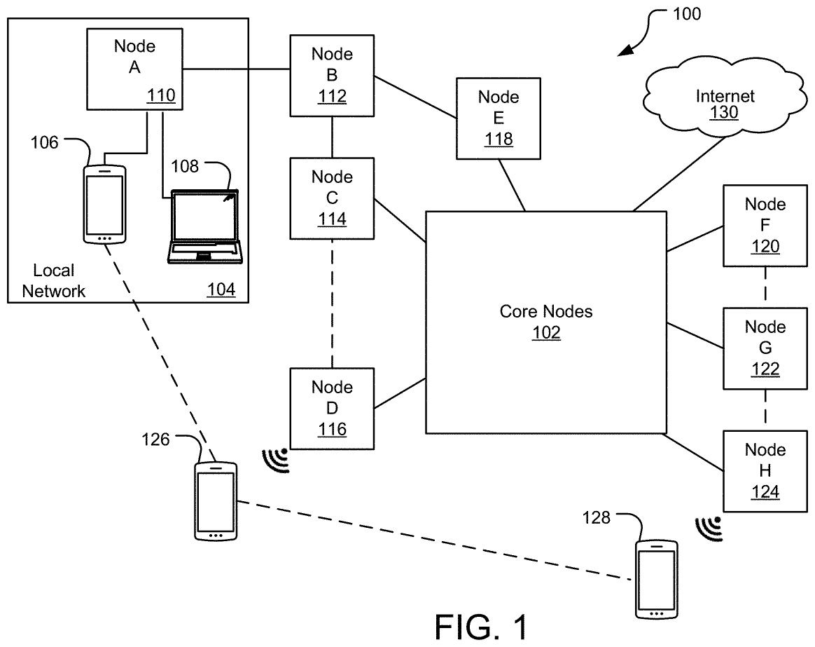

FIG. 1 illustrates an exemplary operating environment 100 an exemplary network operating environment in accordance with one embodiment. In general, the environment 100 provides for a cloudless, decentralized collection of computing devices in communication with each other in a peer-to-peer manner, often without connection to a communications network such as the Internet. A cloudless network of such devices provides for sharing of resources, both hardware and software, to operate or otherwise facilitate the network among some or all of the components of the network that are each capable of running or operating independently of each other. A typical centralized network may be controlled, operated, or managed by a single entity such that a majority of the functions and services needed to facilitate the network are operated by that entity. A decentralized network, on the other hand, may spread the services and other software for operating the network among the devices of the network outside of a single or group of controlling entities. Such networks do not require a connecting device to connect to a centralized database to register with the network to receive services. Rather, a device connecting to the cloudless network described herein may communicate with one or more other devices of the network to register the device and receive the network services, while also becoming a new node to the network.

A portion of a cloudless network 100 is illustrated in FIG. 1. In particular, several computing devices are shown as interconnected in various manners. Although only a few such computing devices are illustrated as part of the cloudless network 100, it should be appreciated that any number of such devices may be included in the network environment 100. Additional devices may also form the cloudless network environment 100 of FIG. 1. For example, the network of devices 102 may include and/or connect with one or more node devices 110-124. In general, a node device 110-124 may be any type of computing device that communicates (often in a peer-to-peer relationship) with other computing devices of the network 100 to share resources, access, and provide services and applications, store and access data and other information and/or otherwise to provide services to connecting computing devices. Some node devices 110-124 are computing devices that may provide a gateway or interface into the cloudless network environment for personal devices, such as mobile computing devices 126, 128, that are in communication with the node device As explained in more detail below, each node device 110-124 with a gateway functionality may include software, programs, applications, services, etc. that are executed by the respective node device to facilitate interactions with other computing devices of the cloudless network. In this manner, the collection of node devices, among other computing devices, provide the communication, processing and/or storage infrastructure for the cloudless network 100.

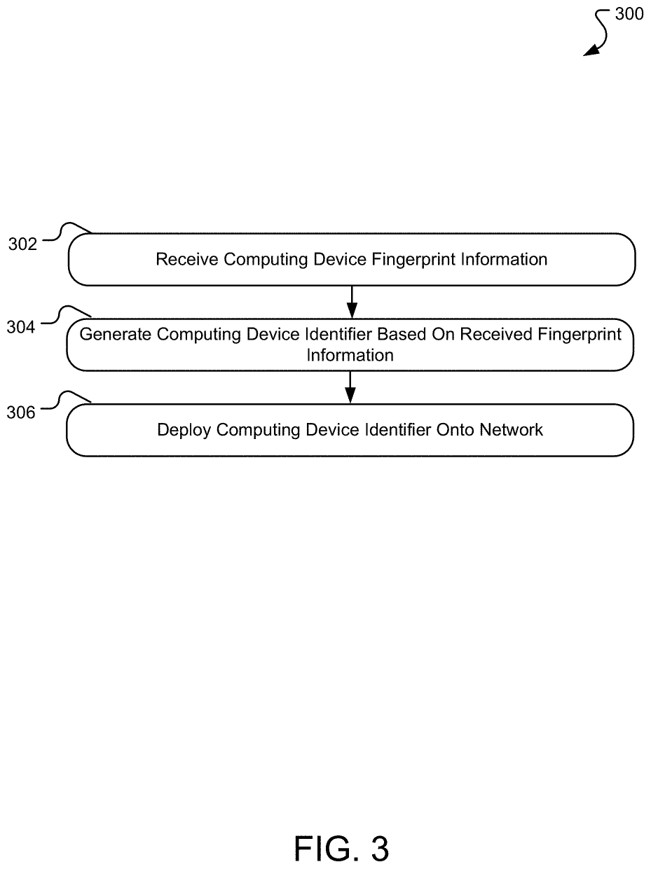

The nodes of the network environment 100 may communicate via any type of physical, wireless, or virtual connections between corresponding devices, often in a peer-to-peer configuration. In the example of FIG. 1, wired or wireless connections between devices are illustrated as a solid line and virtual connections are illustrated with dashed line, although any type of communication medium may be used by the nodes to communicate with each other. Other wireless-type connections, such as WiFi connections, are also illustrated in the environment 100, such as between mobile device 126 and node D 116. In one example but non-limiting configuration, node device A 110 may be located within a local network 104 at a residence or place of business and may be connected to cloudless network via node B 112. In this example, the connection between the node device A 110 and node device B 112 may include a physical or wireless connection, which may also be a portion of a distinct telecommunications network. Thus, node B 112 may connect to the same telecommunications network to which node A 110 is also connected such that communications may be shared between the devices across the telecommunications network. However, the majority of the communications between the nodes 110-124 of the cloudless network occur by way of the direct communication paths between the nodes, with little to no communications transmitted via a telecommunications network or the Internet. In general, node A 110 may communicate with node B 112 via any type of connection (wired or wireless, direct peer-to-peer, via a network, etc.) that provides for the exchange of communication packets between devices. The process of registering node A 110 (or other nodes) to become a device of the cloudless network is discussed in more detail below with reference to FIG. 3.

Customer home or business LAN 104 may include a gateway device 110 to communicate with other devices of the cloudless network and/or personal communication devices such as, but not limited to, a personal computer 108 or mobile computing device 106 in communication with the gateway 110, either through a wired connection or a wireless connection, such as WiFi, Bluetooth, cellular communications, and the like. Here, the node includes gateway functionality and hence it is considered a gateway, among other things. The personal computing devices 106, 108 and the gateway device 110 enable a device at the local network 104 to communicate to the cloudless network of devices, e.g., the various nodes B, C, D etc. and the core nodes 102 to receive services from the other nodes of the network 100, such as access to the Internet 130, to exchange communications, to stream multimedia content, to access application and storage, and the like. Device 106 may be wireless telephone, smart phone, tablet, or portable laptop computer, among other things. Further, in instances where the device 106 is a portable or mobile device, it may reconnect to the cloudless network via another node with a gateway capability when brought within broadcast range or otherwise connected to the other node device. For example, device 106 may be brought within broadcast range of node H 124 at a location separate from the local network 104. Through an exchange of information between the device 106 and the node H 124 (as explained in more detail below), the device may connect to the cloudless network via node H and receive the services available from the network as before. In some instances, one device 106 of the local network 104 may request a service from the cloudless network of devices to be available from node A 110. Once the service is located at node A 110, other devices of the local network, such as computer 104, may also consume the service as available from node A.

In a similar manner as above, node device B 112 may also be connected to or in communication with node E 118 and/or node C 114. Moreover, through a connection with another device, such as the connection of node B 112 to node E 118 or the connection of Node B to node C 114, node B may gain access to the broader network for communication among the devices, among other things. In other instances, node B 112 and node E 118 may be within a wireless communication range such that communications between the devices may be shared directly over the wireless medium. Node C 114 may also communicate with node B 112 over the same or a different communications mechanism. Further, each of node E 118 and node C 114 may connect to still other devices or nodes of the network, including at the network of core devices 102, which may further facilitate communication with other devices. In this manner, components, or “nodes”, of the cloudless network 100 may be interconnected to perform one or more of the procedures described herein, exchange applications and/or services, or otherwise operate as a network of communication devices.

In addition to actual connections, either through a wired medium or a wireless medium, the devices of the cloudless network 100 may establish one or more virtual connections between the network nodes, components, or devices. For example, node C 114 of network environment 100 may not be connected to the same communications network as node D 116 such that a direct exchange of communications between the devices may not occur. However, through the network of devices 100 or other components of the cloudless network 100, a virtual connection between node C 114 and node D 116 may be established to exchange communications, data, programs, etc. In a similar manner, device 106 may not be within a wireless range of mobile device 126 to establish direct communication. However, via the components of the cloudless network 100, the devices 106, 126 may form a virtual connection such that communications and/or data may be shared between the devices 106, 126. This exchange of communications may occur without the devices 106, 126 connecting to a common or centralized device such that the virtual connections may traverse at least a portion of the cloudless network but not necessarily connecting to a centralized network of devices. In a similar manner, other nodes of the cloudless network 100 may establish direct connections or virtual connections. The interconnection of the nodes of the cloudless network 100 is discussed in more detail below and may be such as to reduce the complexity and interconnectedness of the nodes of the network.

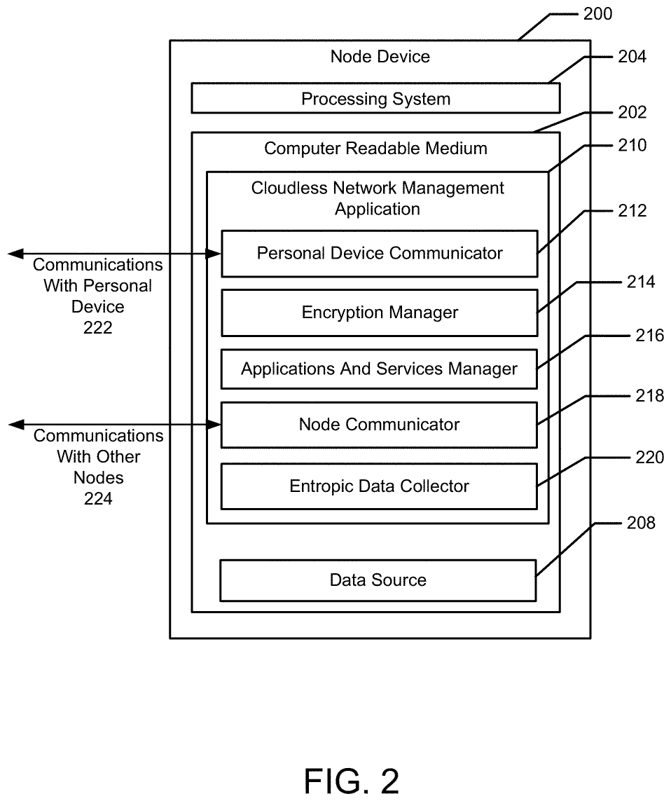

As shown, the network environment 100 may include at least one node device 110-124 through which personal devices 106, 108 may connect to a cloudless network. In general, the node device 110 may be any networking or computing device or multiple networking or computing devices configured to execute a registration process with another node of the cloudless network, as explained in more detail below. One particular example of the node device is illustrated in FIG. 2. FIG. 2 is a schematic diagram illustrating an example node device 200 through which a personal device or other computing device may connect to a cloudless network in accordance with one embodiment. For example, the node device 200 of FIG. 2 may be the node device 110 of the local network 104 discussed above, or any other of the node devices discussed in relation to the network environment 100 of FIG. 1.

In some instances, the node 200 may execute a cloudless network management application 210 to manage the registration of the mode device with the network to become a node of the network and/or perform network operational procedures to facilitate the cloudless network. To operate as a node of the cloudless network, the node device 200 may execute the network management application 210 to perform one or more of the operational procedures described herein. In particular, the network management application 210 may be stored in a computer readable media 202 (e.g., computer memory) and executed on a processing system 204 of the node 200 or other type of computing system, such as that described below. The computer readable medium 202 includes volatile media, nonvolatile media, removable media, non-removable media, and/or another form of tangible available storage medium. By way of example and not limitation, non-transitory computer readable medium 202 comprises computer storage media, such as non-transient storage memory, volatile media, nonvolatile media, removable media, and/or non-removable media implemented in a method or technology for storage of information, such as computer readable instructions, data structures, program modules, or other data.

The network management application 210 may also utilize a data source 208 of the computer readable media 202 for storage of data and information associated with the node device 200. For example, the network management application 210 may store information associated with registering and operating the node device 200 as a node of the cloudless network (e.g., network 100), including generated and/or received encryption keys, identifiable fingerprint information of the node device 200, applications and/or services available from the node, data and information of the cloudless network infrastructure, and the like. In general, any data or information utilized by the network management application 210 may be stored and/or retrieved via the data source 208 such that the node device 200 may operate as a node of the network 100, providing access, programs, services, etc. to connecting devices.

The network management application 210 may include several components to perform one or more of the operations described herein. For example, the network management application 210 may include a personal device communicator 212 to exchange communications 222 with a personal device, such as a smart phone, cell phone, laptop computer, tablet device, etc. For example and returning to FIG. 1, node A 110 may, using the personal device communicator 212, communicate with device 106 and exchange information, communication packets, data, etc. 222 between the devices. In some instances, the personal device communicator 212 may utilize a wireless protocol to communicate with the personal device, such as WiFi, Bluetooth, Near Field Communications (NFC), and the like. In one particular instance, the personal device communicator 212 may generate a WiFi hotspot for communicating wirelessly with a personal computing device. The personal device communicator 212 may utilize other communication protocols to communicate with personal computing devices, included wired or wireless protocols.

The network management application 210 may also include an encryption manager 214 for generating, communicating, and otherwise managing identification data and information of the node device 200 for registering and operating the node of the network, including but not limited to encryption keys, registration information, device fingerprint information, and the like. As explained in more detail below, the encryption manager 214 may communicate with other nodes of the cloudless network to register the node device 200 with the network. In some implementations, the encryption manager 214 may transmit node device identification information (such as hardware and/or software fingerprints associated with the node device 200) and/or entropic data or information or measurements utilized by the network for generating encryption keys or other information for the node device, receive encryption keys associated with the node device 200 from one or more nodes of the cloudless network, store and manage encryption keys for the node device 200, and/or communicate with one or more personal devices to ensure secure communication and sharing of information or data between the personal devices and the cloudless network. Several of such operations executed by the encryption manager 214 are included in the methods described herein.

The cloudless network management application 210 may also include an applications and services manager 216 to manage applications and servers supported by the node device 200. In general, services are programs utilized by the network management application 210 to operate the node device 200 as a node of the cloudless network in conjunction with other nodes of the network. For example, a network service may provide shared computing, networking, storage, and other computing resources among one or more of the nodes of the network. The management of such shared resources may be controlled or otherwise managed by the applications and services manager 216 of the network management application 210 via communication between the node device 200 and other nodes of the network to coordinate the sharing of the network resources. Applications may utilize such shared resources to provide solutions for devices of the network, including personal devices in communication with the node device 200. For example and with reference to FIG. 1, personal device 106 may execute an application that utilizes services provided by cloudless network 100 via node A 110. An applications and services manager 216 may determine the network resources needed to execute the application, including networking, storage, computing power, etc. being requested of the network by the application. The applications and services manager 216 of the node device 110 may, in response, execute one or more service programs to request shared resources with other nodes, communicate with other nodes, determine availability of resources of the other nodes, and the like. In this manner, the applications and services of the cloudless network may work in tandem to request and manage resources available from the nodes of the network and consume those shared resources. Many of the operations of the services and applications may thus be managed by the applications and services manager 216 of the network management application 210 of the node device 200. Additional operations of the services and applications associated with the cloudless network are discussed in greater detail below.

A node communicator 218 may also be included with the cloudless network management application 210 to communicate 224 with other nodes of the network 100. As mentioned above, nodes of the network may share resources for applications executed on the nodes or personal devices in communication with the network. Communications 224 between the nodes sharing resources may be exchanged to coordinate and/or manage the sharing of the resources between the nodes. For example, an application executed on personal device 106 of local network 104 may request an amount of storage to operate. In some circumstances, node A 110 may not have enough storage availability to satisfy the request from the application and may request additional storage space from node B 112 or any other node of the network 100. One or more services executed by node A 110 may communicate, utilizing the node communicator 218, with one or more other nodes of the network 100 to request and obtain the storage capacity for or needed by the application. In general, any communications 224 for managing the registration, operation, and/or configuration of the nodes of the cloudless network 100 may be transmitted and/or received via the node communicator 218.

Communications 224 between the nodes of the network may occur via any known or hereafter communication medium. For example, the node devices may be communicate through a peer-to-peer connection over a wireless connection, such as over WiFi, Bluetooth, cellular communications, and the like. In this manner, the node devices may communicate directly (one-to-one connection) in a cloudless, decentralized infrastructure to provide the services and transactions between the node devices and/or the computing devices connected to the cloudless network via a node device 200.

In addition, the cloudless network management application 210 may include one or more entropic data collectors 220 to obtain, in one instance, a measurement of some aspect of the environment or other physical characteristic associated with the node device 200 and/or a device in communication with the node device. In another instance, the entropic data collectors 220 may receive other randomized digital data from one or more sources associated with the node device 200. In one particular example, the entropic data collectors 220 may include sensors or other mechanisms (e.g., connection to a remote sensor) to obtain a temperature, humidity, atmospheric pressure, light, and/or sound measurements from the environment around the node device. In another example, one or more bio-measurements associated with a user of a personal device, such as personal device 106 of FIG. 1, may be obtained and transmitted to the entropic data collectors 220 of the node device 200. In general, any sensor 220 or other type of data collector may be included or associated with the node device 200 for obtaining entropic digital data or information. As explained in more detail below, such random data may be used to generate encryption keys or other secure information or data for secure operation and communication of the cloudless network 100.

It should be appreciated that the components described herein are provided only as examples, and that the cloudless network management application 210 may have different components, additional components, or fewer components than those described herein. For example, one or more components as described in FIG. 2 may be combined into a single component. As another example, certain components described herein may be encoded on, and executed on other computing systems.

As described above, the node device 200 may operate as a node of the cloudless network 100 such that other devices of the network may communicate with the node device to receive services from the network or otherwise interact with the cloudless network. In some instances, the node device 200 may be a computing device on which the cloudless network management application 210 may be executed. In another instance, the node device 200 may be manufactured particularly to operate as a node of the cloudless network 100, otherwise known as a core node of the network. Regardless of the structure of the node device 200, identification and registration of the device with other devices of the network 100 may occur such that the device 200 may securely operate as a node of the cloudless network 100.

Through a registration process with the cloudless infrastructure, a computing device may become a node of the cloudless network 100 and begin providing services to other nodes and/or other computing devices. In one instance, the node device may be an interface to access the cloudless network for a personal device to begin receiving services from the network at the personal device. For example and referring to the environment 100 of FIG. 1, node device A 110 may register with the network environment 100 through the process described above. Once registered as a node of the cloudless network 100, the node 110 may provide an interface to personal devices, such as mobile device 106 and/or laptop computing device 108. In other words, the personal devices 106, 108 may access the cloudless network via node A 110 (operating as a gateway into the network) to begin receiving services from the network, such as storage, computing, and/or networking services, among others. In one particular example, the personal device 106 may receive streamed multimedia content from the network via node A 110 for display on the personal device.

A personal device connecting to the cloudless network 100 may be associated with a device identifier similar to the node identifier described above to interact with the network devices and services. FIG. 3 is a flowchart illustrating one method for generating a device identifier for a personal computing device communicating with a cloudless network in accordance with one embodiment. In one example, the personal device may be mobile device 106 of FIG. 1, although any computing device may request connection or to receive services from the cloudless network 100. In one implementation, the operations of the method 300 of FIG. 3 may be performed by a service and/or application executed on a node of the cloudless network. For example, node A 110 of FIG. 1 may include a service or application for registering personal devices with the cloudless network and may perform the operations of the method 300 of FIG. 3.

Beginning in operation 302, a node of the network may receive fingerprint identifiers or other device related information from the device requesting a network identifier. Similar to above, the fingerprint information may include identification information of the hardware components of the device 106, such as serial numbers, model identifiers, manufacturing information, and the like. The hardware information of the device 106 may be obtained from an application executed on the device and configured to query one or more components of the device for the hardware-based identification information. In some instances, the program executed on the device 106 may combine, utilizing an algorithm of the application, the hardware information of the device into a hardware fingerprint that identifies or is otherwise associated with the particular device. As should be appreciated, different devices may include different types of hardware components such that a hardware fingerprint based on the components of the device may be different than other hardware fingerprints of devices with different hardware components. The application executed on the device may also obtain software information of one or more programs stored on the device to generate a software-based fingerprint. The generation of the hardware and/or software fingerprint information may be the same or similar as that described above with reference to the node device. Regardless of how the device fingerprint information is generated, the device (and, more particularly, the application executed on the device) may transmit the generated fingerprint information to a node of the network for processing by a service and/or application executed on a node of the network.

In operation 304, one or more nodes of the network may generate an identifier for the device 106 based on the fingerprint information received from the device (e.g., a personal device). The generation of the identifier may be the same or similar to that described above in relation to generation a node identifier, in some instances. For example, the one or more nodes may execute an algorithm, such as a hashing function, to convert the hardware and/or software fingerprint information from the device into a unique device identifier. The device identifier may therefore be different than identifiers generated for other nodes and/or devices of the cloudless network 100 such that the device identifier may be utilized to identify the specific device to the network. Other information of the device may also be used to generate the device identifier. For example, connection information of the device, such as last known Internet Protocol (IP) address of the device, a communication protocol for communicating with the device, one or more communication port identifiers, one or more device identifiers, and the like, may be used by the node device to generate the device identifier. Further, because the device identifier is based on aspects of the specific device itself (such as the hardware and software components of the device), the identifier may be linked to the physical device and not a user of the device. In this manner, a user's information is not associated with interactions undertaken with the cloudless network. Rather, only aspects of the device are used to generate the device identifier for use by the network, thereby allowing users of the network to remain anonymous and secure. Rather, the identifiers utilized in the cloudless network may be linked to the devices themselves.

The generated personal device identifier may be deployed onto the cloudless network in operation 306 for storage in one or more nodes of the network. The one or more nodes of the network may store a received device identifier in a table or other storage configuration of such identifiers for use in communicating with the device, providing services to the device, managing one or more accounts associated with the device, and the like. In general, any interaction with the network by the device may utilize the generated device identifier and may be verified by the nodes of the network via the deployed and stored device identifiers.

The device identifier may be utilized by applications and/or services of the network as a substitute identifier for a user associated with the network, without storing or transmitting personal information of the user of the device. For example, applications and/or services may be configured to use a device identifier as a signature or other identifier of a user, rather than actual user information. Thus, a user of the device may use the device identifier to agree to contracts, purchase goods, log into websites or systems, authorize transactions, and the like without providing sensitive personal information. If the device identifier is ever stolen, the user's personal information is not available from the device identifier and a new device identifier may be generated for the user's new device when the stolen device is replaced. In this manner, the identifier used within the cloudless network may be more secure than other types of user identifiers that typically include some personal information of a user.

Security/Encryption of Network Components

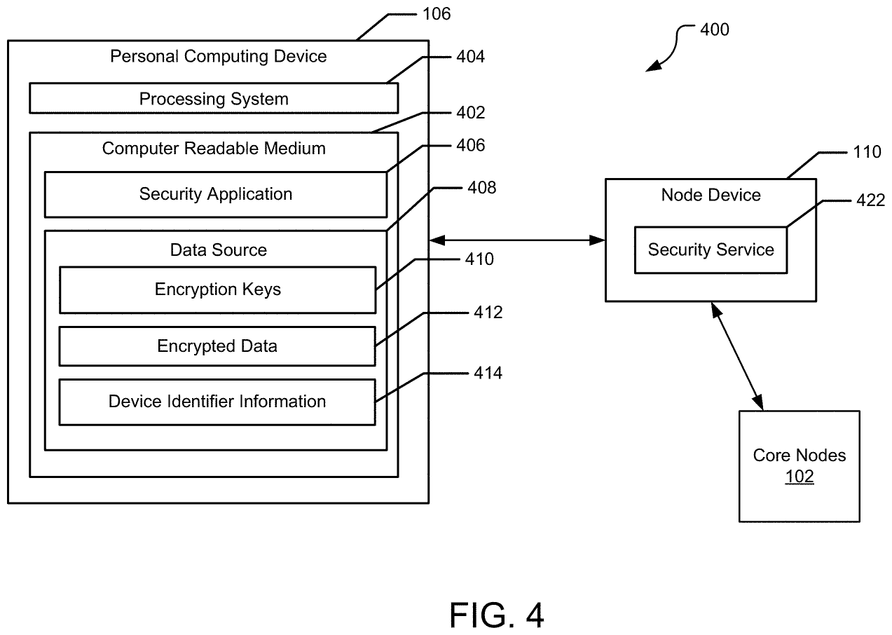

In addition to the device identifier, other security measures, features, and/or services may be associated with the cloudless network to ensure safe and reliable interactions with the network. FIG. 4 is a schematic diagram illustrating an exemplary network operating environment 400 for providing secure interactions with a cloudless network in accordance with one embodiment. The environment 400 includes a cloudless network of devices 102, a node 110 providing access to the cloudless network, and a computing device in communication with the node to receive one or more services from the network. The network of devices 102, node 110, and computing device 106 may be the same or similar to the devices discussed above with reference to FIGS. 1 to 4, although the computing device may be any computing device, such as a mobile computing device, a laptop, a tablet, etc. Also, the node 110 may be any node or computing device of the cloudless network in communication with the computing device 106. In one instance, one or more other nodes may be logically positioned between the computing device and the node such that communications between the devices may occur over any number of nodes of the cloudless network. In general, the node 110 may be one or more nodes of the cloudless network 102 executing a security service application 422 or program to provide secure transmissions to devices connected to the network.

The environment 400 may include an example personal computing device 106 in communication or otherwise associated with the cloudless network 102 which may receive services from the network, such as compute services, storage services, networking services, security services, and the like. While the term “personal” computing device is used to reference device 106 and the device may be associated with a particular user in some instances, the device is not limited to so-called personal computing devices and may be other forms of devices including IoT devices, various network devices, nodes as described herein, servers, etc. In general, the user of the term “personal computing device” is used herein to differentiate from node devices 110 and core nodes 102 of the network 100. In some instances, the personal computing device 106 may include a processing system 404 for executing a security application 406 stored in a computer readable medium 402. The security application 406 may be executed to facilitate secured communications with devices of the cloudless network 102, such as node device 110. By way of example and not limitation, non-transitory computer readable medium 402 comprises computer storage media, such as non-transient storage memory, volatile media, nonvolatile media, removable media, and/or non-removable media implemented in a method or technology for storage of information, such as computer readable instructions, data structures, program modules, or other data.

The security application 406 may also utilize a data source 408 of the computer readable media 402 for storage of encrypted data and other information associated with the security application 406 or other applications stored on and/or executed by the personal computing device 106. For example, the security application 406 may store security and/or encryption information and data, such as encryption keys 410 (both private and public encryption keys), encrypted data for use by applications of the personal computing device 106 and the network 102, device identifier information 414, and the like. In one particular example, the device identifier for the personal computing device 106 obtained from the network 102 based on the method described above and stored in the data source 408, either encrypted or non-encrypted. In general, any data or information utilized by the personal computing device 106 may be encrypted and/or stored in the data source 408 and accessible via the security application 406 executed by the processing system 404 of the personal computing device 106.

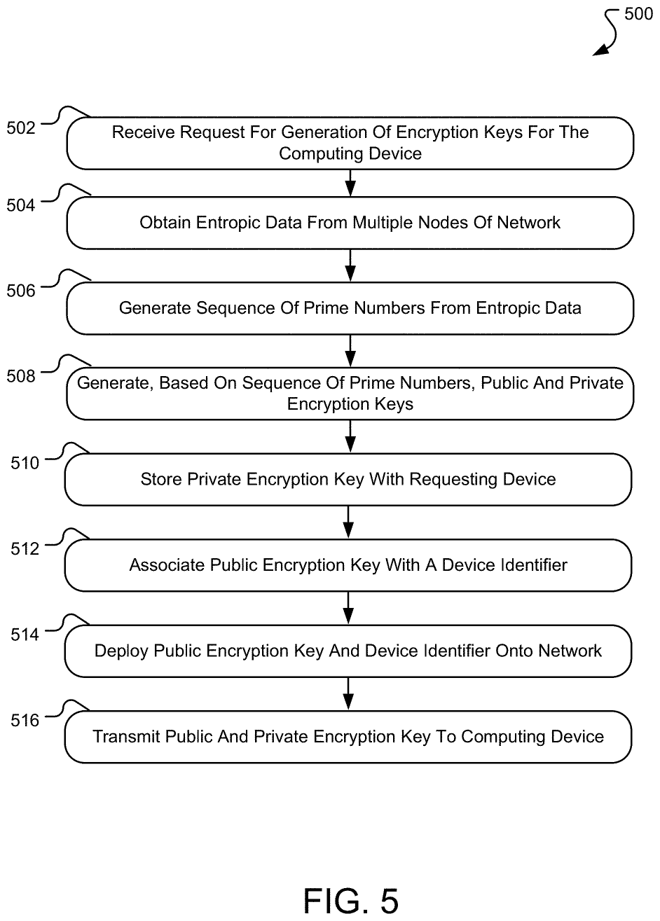

As mentioned above, the cloudless network may provide a security service 422 to personal devices (or any other devices associated with the network). The personal computing device 106 may utilize the security service 422, in one instance, to generate encryption keys for use in encrypting communications and/or data for secure communications across the cloudless network. More particularly, the personal computing device 106 may access a security service 422 of one or more node devices of the network and request encryption keys from the network as generated by the security service. In response, the security service 422 of the network may execute the method 500 illustrated in FIG. 5. In another instance, the security application 406 of the personal computing device 106 may execute a program to generate the encryption keys for the device. Thus, each device of the cloudless network may request generation of encryption keys from a service of the network or may execute a security application to generate the encryption keys for the device. In either regard, the security service/application may perform the operations of the method 500 of FIG. 5 to generate encryption keys for a computing device 106 associated with a cloudless network. In one embodiment, the operations of the method 500 may be executed by one or more nodes of the cloudless network 102 via a security service program 422 executed on the one or more nodes.

Beginning in operation 502, the security service 422 or application 406 may receive a request to obtain one or more encryption key pairs for encrypting data, information, communications, and the like associated with the computing device. As mentioned above, the security service 422 may be distributed across multiple nodes of the cloudless network 102 which may work in tandem to provide the security service for the computing device 106. In other instances, a security application 406 stored and executed by a corresponding computing device may begin the process of generating encryption keys for the device itself. The request for the encryption keys may include, in some instances, a device identifier generated via the methods described herein and any other computing device information that may be utilized to generate the encryption keys for the computing device. In another example, a security application 406 may be loaded and executed on the computing device 106 to obtain or generate the encryption keys for the device.

In operation 504, the security service 422 or security application 406 may obtain entropic digital data from one or more nodes of the cloudless network. In particular and as explained above with reference to the node device 200 of FIG. 2, the nodes of the network may include one or more entropic data collectors 220 configured to obtain entropic digital data for use in generating encryption keys for the network. In one example, the entropic data collectors 220 may include one or more environmental sensors to obtain a temperature, humidity, atmospheric pressure, light, and/or sound measurements, and the like from the environment around the node device. The environmental measurements may be obtained at different times of the day to obtain varied measurements of an environment around the node device 200 or personal computing device 106. Further, the measurement values may be expressed in any corresponding measurement units or scale. For example, temperature measurements may be expressed in degrees Celsius, degrees Fahrenheit, degrees Kelvin, etc. Sound measurements may be expressed in decibels, sones, phons, etc. Other types of entropic data may also be obtained for computing devices of the cloudless network that are associated with a user. For example, a personal computing device 106 in communication with the cloudless network may obtain one or more bio-measurements of a user or users within the vicinity of the device, such as body temperature, heart rate, accumulated steps in a time period, etc. The user-related data may similarly be expressed in any corresponding measurement units or scale. In yet another example, entropic data may be provided to the entropic data collector 220, such as through a keyboard or other input device to the node device 200. In general, any randomized or entropic digital data may be obtained by the entropic data collector 220 of the node device 200. Further, the entropic data may be constantly changing over time such that the entropic data collectors 220 may provide a source of entropic and random data or information.

The accumulated entropic digital data may be stored at the respective node or device that obtains the data, in one instance of the operations of the network. In another instance, the nodes and/or computing devices of the network may be configured to transmit the obtained entropic data to a database, service, application, or the like of the network. Thus, the entropic information may be obtained or received from any number of nodes of the network over the geographic footprint of the cloudless network. For example, temperature measurements from a device in Brazil, humidity measurements from a device in England, a heart rate of user in Australia, a sound measurement from a device in New York City, and more may be obtained and used by the method 500 described herein. To improve the randomness of the entropic data, the device location and type of data may be randomly selected from the nodes of the network and the available information.

The security application 422 may request the entropic data from one or more selected nodes of the network, in one instance. In another, the security application 422 may communicate with a database of such information configured to collect the entropic information from the nodes of the network 100 and store the information for use in generating an encryption key pair. Regardless of the method by which the entropic information is obtained, the security application 422 may generate a sequence of prime numbers from the entropic data in operation 506 of method 500. More particularly, the security application 422 may execute an algorithm that transforms the entropic values into a sequence of prime numbers, such as through a hashing function or other mathematical algorithm. Further, because the inputs to the algorithm are randomized as obtained from a random collection of data from a variety of locations/devices, the sequence of the prime numbers is similarly randomized. In operation 508, the security application 422 may generate, based on the sequence of prime numbers, a pair of encryption keys for the personal computing device 106 that the personal device may utilize to encrypt data associated with the device. In one instance, an encryption key may be generated from the entropic information in a symmetric-key encryption scheme. In such an encryption scheme, data may be encrypted using the encryption key and decrypted using the same key.

In another instance, the pair of encryption keys generated from the entropic data may be a pair of public and private encryption keys for use in an asymmetric encryption scheme. In some instances, the sequence of prime numbers generated from the entropic data may comprise the public encryption key and/or private encryption key for the personal computing device 106. In another instance, the sequence of prime numbers may be transformed, utilizing a mathematical algorithm, into a public and/or private encryption key. The generated private encryption key for the requesting device may be stored with the requesting device in operation 510. For example, security service 422 may perform the above operations for node 110 to generate a private encryption key for the node, which may be stored at the node. In another example, the security application 406 of the personal computing device 106 may perform the above operations for the personal device to generate a private encryption key for the device, which may be stored in the data source 408 as encrypted key 410. In still another example, security service 422 of the node 110 may generate the private encryption key for the personal computing device 106 and transmit the private encryption key to the personal computing device for storage in the data source 408. As explained in more detail below, the private encryption key may be used by corresponding device of the network for which the key is generated to encrypt data, communications, information, etc. associated with the device.

In operation 512, the generated public encryption key may be associated with a device identifier for which the encryption key is generated. For example, the public encryption key generated for node 110 may be associated with the node identifier of the node, perhaps generated via a method described above. In another example, the public encryption key generated for personal computing device 106 may be associated with the device identifier of the personal computing device. In operation 514, the public encryption key and the associated device identifier may be deployed onto the cloudless network 102 for storage. The public encryption key and associated device identifier may be stored in any number of nodes of the cloudless network 102 and may, in some instances, be managed by the security service 722 executed on one or more of the nodes of the network. Further, in operation 516, the generated public and private encryption keys may be provided to the requesting computing device for use in encrypting device and/or communications associated with the computing device. Through the method 800, one or more encryption keys for the devices of the cloudless network 102 may be generated from the entropic data obtained from the nodes of the network.

The devices of the cloudless network may utilize the encryption keys to encrypt transmissions and/or data associated with the network. For example, the encryption public key for a particular device of the network may be identified based on the corresponding device identifier and used to encrypt communications, data, information, and the like sent to the device identified by the device identifier. The device associated with the public key may, in turn, utilize the private encryption key to decrypt the encrypted data. In a similar manner, the device may utilize the private encryption key to encrypt data which may be decrypted by another node of the network utilizing the public encryption key. In general, any data, communications, information, etc. associated with the network and/or devices of the network may be encrypted utilizing the generated encryption keys. As shown in the environment 400 of FIG. 4, the personal device 106 may store encrypted data 412 in the data source for use by applications executed by the device. Such encrypted data may include passwords (such as a WiFi password for accessing a node device), wireless network encryption, personal information, data used by applications and/or services of the network, communications transmitted via the cloudless network, and the like.

In addition, the entropic data obtained from the entropic data collectors 220, as illustrated in node device 200 of FIG. 2, allows for the rotation of encryption key pairs at a faster rate than in other encryption systems. Traditional encryption keys are rotated or refreshed, on average, every six to twelve months because of the computationally-intensive difficulty in generating a random sequence of prime numbers from which encryption keys may be based. Through the use of the entropic data, however, the more random base of information from the entropic data may be leveraged to reduce the compute power needed to generate the sequence of prime numbers. As a result, the encryption keys may be generated at a faster rate such that rotation of such keys may occur more frequently when compared to other encryption schemes. This increase in encryption key rotation may reduce the opportunity for a malicious third-party to obtain or recreate the encryption key pair and fraudulently access a user's encrypted data as each encryption key may be used for a shorter period of time than previous encryption key systems.

The entropic data may also be processed or analyzed by correlating the data to network and/or social events occurring within the geographic area from which the data is obtained. For example, data obtained from a particular node may be associated with a geographic area of the node's location and further associated with events within the same geographic area. Such correlations may allow extraction of statistical data from the entropic data, such as news, weather, crime, and the like. The correlated data may, in some instances, be commoditized in a safe and anonymous manner while linking the digital world to real world events. Because the data is not targeted or based on individuals but rather devices, the anonymity of individuals associated with the data is maintained, while still providing the obtained and analyzed information. For example, when a low barometric pressure is measured in a certain area, analysis of the data may be correlated to a certain time frame of certain food consumption. Additional examples include corresponding the data to entertainment consumption and/or ordering certain products or goods. Users of the network may sell their data for some type of compensation.

The entropic data may also be obtained in a manner that reduces the overall energy consumption for generating the encryption keys or otherwise providing security to devices and applications associated with the infrastructure. For example, many computing devices consume large amounts of energy in generating a random number seed from which encryption keys may be created. In general, the more complex the random number generation process, the more processing power is needed, leading to more energy consumption by the computing devices. In contrast, the use of entropic data obtained from multiple sensors in multiple locations and randomly combined requires significantly less processing time and energy to complete. Additional benefits of using entropic data for security of data in the cloudless infrastructure are discussed in more detail below in relation to the transaction management service.

Network Resource Sharing Management

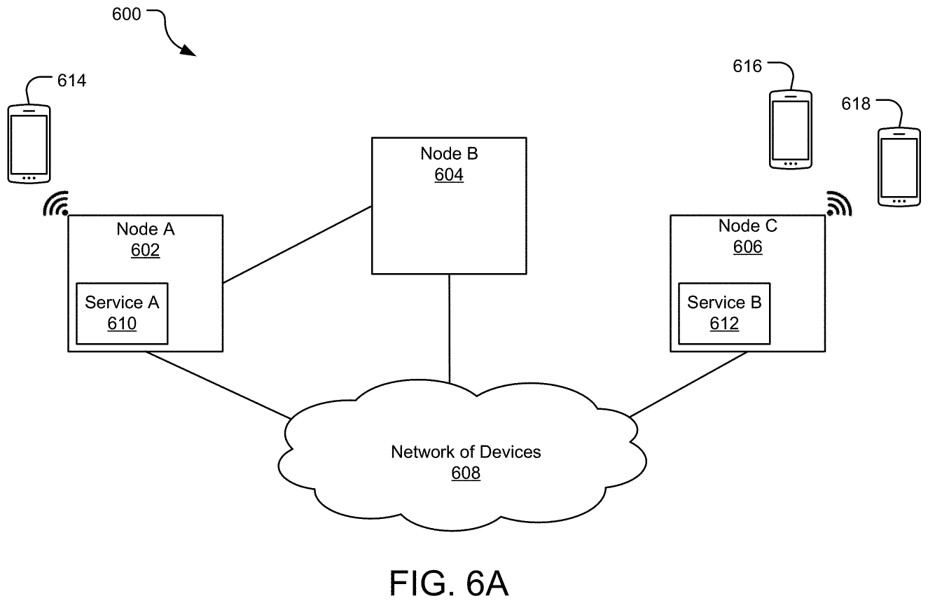

As mentioned above, the resources of nodes of the cloudless network may be shared. So, for example, a service, which may be running on a computing device using the network, may share resources of nodes, such as compute power, data storage, processing speed, and the like, to provide the service. In one implementation, one or more nodes or devices of the network may generate and utilize a numerical value, also referred to herein as a “density” value, of the available or consumed resources of the devices of the network to manage sharing of resources among the nodes. FIG. 6A illustrates the distribution of network resources among nodes of a cloudless network based on a density value of node resources in accordance with one embodiment. The components of the network environment 600 of FIG. 6A are the same or similar to those described above. In particular, FIG. 6A includes a cloudless network of computing devices 608 interconnected as described above and including node device A 602, node device B 604, and node device C 606, one or all of which may be a node device as described above. The node devices 602 to 606 may be in communication with the cloudless network of device 608 and/or each other, either through a wired or wireless connection. In addition, one or more personal computing devices 614 to 618 may be in communication with one or more of the node devices 602 to 606, either through a wired or wireless connection. The nodes 602-606 and/or personal computing devices 614 to 618 may register with the cloudless network 608 and receive a unique device identifier via the methods described above and may encrypt communications and/or data via encryption keys as described above.

As illustrated in the network environment 600, node A 602 may have an instance of service A 610 installed on the node for availability to personal computing devices, such as mobile phone 614, to receive the associated service. For example, service A 610 may include a security service for an application executed on the personal computing device 614 to encrypt data, generate and provide encryption keys, or provide other types of security features. Similarly, node C 606 may have an instance of service B 612 installed on the node and available to personal computing devices 616. For example, service B 612 may be a service to provide multimedia content to personal computing devices 616 via an application executing on the personal devices. Service B 612 may therefore provide Domain Name Server (DNS) services, manage communications with content providers, cache multimedia content, and the like. In general, however, the services 610, 612 installed on the respective nodes of the network 608 may provide any network service to connected devices 614 to 618.

In one instance, personal computing device 618 may connect or register with node C 606 to access services available from the cloudless network 608, via the registration process described above or by providing a previously registered personal computing device identifier. Once connected to the cloudless network of devices 608, an application executed on the personal computing device 618 may request a particular service from the network. In one example, the requested service may be service A 610. Node C 606 may determine, in response to the request, that service A 610 is not installed on the node to provide the service to the requesting device and may begin a process of downloaded, from the devices of the cloudless network 608, the service for execution on node C 606. However, service B 612 may consume a large amount of the resources of node C 606 such that node C may not have enough available resources (storage space, processing speed, etc.) to download and execute the requested service. In this circumstance, node C 606 may utilize resources from other nodes of the network to provide the requested service to the personal device 618. In one particular implementation, a density value indicating available node resources may be associated with the nodes of the network and may be used by node C 606 to determine the sharing of resources among the nodes. One particular method for utilizing a density value associated with a node to share resources among the nodes of the infrastructure is disclosed in U.S. Provisional Patent Application No. 63/132,285, entitled “Systems and Methods for Creating and Operating a Cloudless Infrastructure of Computing Devices”, the entirety of which is hereby incorporated by reference.

One or more nodes of the infrastructure may be associated with a density value indicative of the available resources for that node. For example, node C 606 may have particular resources for operating as a node in the network, such as one or more processors, memory storage space, open communication ports, etc. Portions of the resources may be consumed by applications and/or services executed on the target node, such as an amount of memory space used for a particular service, consumption of a processing pipeline of the node, and the like. Thus, one or more portions of available (or free) resources of the node 916 not allocated to other services or being used by services and/or applications may be determined, such as available processing speed, available memory space, available communication ports, available bandwidth, and the like. As should be appreciated, the more services and/or applications stored on and executed by the node 906 may reduce the available resources of the node device, while fewer stored services may increase the available resources of the device.

The measurements of available resources from the node device 606 may be combined and converted into a density value via an algorithm, process, calculation, and the like. For example, it may be determined that node C 606 has 100 Gigabyte per second of processing speed available, 10 Gigabyte of memory space, and four communication ports available or otherwise not being consumed by services and/or applications of the device. Each of these measurements may be converted into a relative value and combined to provide an overall density score or value for the node 606. The conversion of available measurement values into a density value for the device may take many forms or algorithms. Regardless of the particular formula, algorithm, or process used to calculate the density value for the node 606, the density value indicates the available resources (compute, storage, and/or network) of the node device 606 that may be shared with other nodes of the network. In this manner, the density value calculated or otherwise determined for a node of the network may be used to manage sharing of resources among the devices of the network.

Further, density values for one or more node devices of the network that neighbor a target node device may be obtained or determined. In some instances, the neighboring nodes to the target nodes may be any node in direct logical communication (e.g., not via another node of the network) with the target node. In another instance, the neighboring nodes of a target node may include all nodes within a geographic region, such as all nodes within a 50 mile radius of the target node, regardless of the layer of the nodes or the number of nodes between the target node and the other nodes. In still another instance, the neighboring nodes may be nodes within the same fractal network or layer within the cloudless network, as explained in more detail above. In yet another instance, the neighboring nodes may include any portion or all of the nodes of the cloudless network. For example, in the instance in which a node of the network is dedicated to managing the sharing of resources of the all or some of the nodes of the network, available resource measurements for all or a large portion of the nodes of the network may be obtained by the dedicated node. In general, a neighboring node may include some density component or measurement, such as a time needed to transmit data between the target node and the neighbor node (or latency between the devices), compute capacity, storage capacity, etc. or other measurement based on the efficiency of network communications, to limit the number of nodes in the cloudless network that may be considered a neighboring node to another node of the network. Each node may generate, receive, and/or store a neighboring node density value for each neighboring node such that the target node may determine which other nodes in the network qualify as a neighbor and which do not for sharing resources. To determine the density value for a neighboring node, the target node may utilize the same algorithm as above to determine its own density value. In this manner, a density value for any number of neighboring nodes of the cloudless network may be obtained to aid in sharing of resources among the nodes of the network. The density values of the target node and/or the neighboring nodes may be stored for use in determining allocation of shared resources.

The density values of the target node and/or the neighboring nodes may be stored for use in determining allocation of shared resources. For example, node C 606 may receive a request from an application executed on mobile phone 618 to receive service A 610. The node 606 may determine if an instance of the requested service is available from the node. For example, the node 606 may access a storage medium to determine if the requested service is stored at the node or otherwise available for execution and use by the application of the personal computing device 618. If the requested service is available from the node 606, the node may provide the personal device access to the service. However, if the node 606 does not include the service, the node (or other computing device of the cloudless network) may begin a process of sharing resources among nodes of the network to obtain the service or otherwise make the service available to the requesting device.

In particular, the node may determine the density value needed for the requested service. In general, any service deployed onto the cloudless network may be associated with a density value that indicates device resources needed to execute or otherwise provide the service to a requesting device. The density value of the target node (such as node C 606) may be compared to the density value of the requested service to determine if the node device has enough resources available to download and operate the requested service. If the density value of the target node device is less than the density value associated with the requested service, one or more resources may be shared among the nodes to free up resources in the targeted node. For example, it may be determined to migrate service B 612 from node C 606 to neighboring node B 604. An example of this migration is illustrated in the environment 620 of FIG. 6B. Following the migration of service B 624 to node B 604, an instance of service A 622 may be downloaded and executed at node C 606 for use by personal computing device 618.

The decision to migrate the service 612 to node B 604 may be based on several factors. For example, the density value associated with node B 604 may be determined and compared to the density value associated with service B 612 to ensure that the node has enough capacity to accept migrated service B 612. In some instances, density values for all or some of the neighboring nodes of the target node may be analyzed to determine those nodes with a density value high enough for migration of service B 612. Another factor that may be considered is a distance, such as a geographical distance or a transmission distance, between the target node and the node to which a service may be migrated. In general, migration of a service to another node of the network may favor a shorter distance between the two nodes to reduce the transmission strain on the network of device 608. Thus, neighboring nodes to the transmitting node may be ranked based on distance from the transmitting node to further refine the selection of the node to which a service may be migrated. Other factors, such as type of connections between communicating nodes, number and type of personal computing devices in communication with the available nodes, types of services being migrated, and the like. In some instances, the neighboring nodes may be ranked based on these factors to determine a node to which a service may be migrated to free up resources on a target node and to increase the density value associated with the target node.

The density values for the nodes of the cloudless network may also be used to expand the density of the network through addition of more nodes to the network. For example, the process described above for associating a layer value or identifier to a new node of the network may utilize a density value of the nodes of the network to determine which layer a new node is assigned. The density value of any number of nodes in a target layer or any other layer may be taken into account when determining to which layer a node may be assigned. In another example, a service may be executed on the network to monitor the density values of clusters of related nodes, such as nodes in a defined group, nodes in a particular geographic region, nodes sharing particular services, and the like. The monitored density values may be compared to a threshold density value for each node or for a group of nodes of the network. If the density values of the monitored nodes equals, exceeds, or otherwise indicates a lack of available resources in the group of nodes, additional nodes may be added to the group of nodes of the network. In one instance, one or more inactive nodes of the cloudless network may be activated and/or registered with the network to add additional resources into the network to which services and/or applications may be migrated, as discussed above. For example, a service executed on the cloudless network may communicate with one or more inactive nodes and begin the process of registering or otherwise activating the inactive nodes with the network. Upon activation, one or more services may be migrated to the newly activated nodes to reduce the density value associated with one or more nodes of the network.

Transaction Management Service

In one particular implementation, the cloudless infrastructure may provide a transaction management service that, in some instances, utilizes various other services provided by the infrastructure to initiate or complete a transaction of assets. For example, nodes of the cloudless infrastructure may include an asset management service or digital “wallet” to manage assets associated with a user of the infrastructure or a device in communication with the infrastructure. In some instances, one or more assets managed by the asset management service may be exchanged for another type of asset, may be used to pay for good or services, may transferred to another digital wallet, and the like. The transaction management service, which may be executed on one or more of the devices of the cloudless infrastructure, may facilitate such transactions in a fast and secure manner. In general, the transaction management service may manage an exchange of assets between entities. Such assets may include physical assets, digital assets, and/or a combination of physical and digital assets referred to herein as a “hybrid asset”. In some instances, the transaction management service may execute a recursive function for converting an initial asset type into another asset type for the transaction between the entities. Exchange of assets may occur over the infrastructure and may, in some implementations, include communication with third-party entities or systems to facilitate the transaction. In addition, exchange of assets may include lending assets for a particular time, renting assets, licensing assets, and/or selling assets so as to convert the initial asset into another infrastructure-supported asset rather than converting the initial asset to an equivalent monetary asset. In some instances, a market of assets may be hosted by the cloudless infrastructure for exchanging or converting such assets using the recursive function or any other function of the transaction management service. The asset market may similarly be managed by the transaction management service available from the cloudless infrastructure. In one implementation, the transaction management service may also utilize one or more secure identifiers associated with a device of the infrastructure or in communication with the infrastructure and/or one or more secure identifiers associated with a user or entity of a device of the infrastructure to identify and securely exchange assets during a transaction.

The recursive function of the transaction management service may, in some instances, include an optimization technique for determining the initial asset type and/or the exchanged asset type to use in the transaction that optimizes a parameter of the exchange. For example, the optimization technique may determine or obtain one or more parameters of different types of transactions or assets that may then be compared to determine or identify particular asset exchanges that optimizes the one or more parameters. Such transaction parameters may include, but are not limited to, a time to process, an amount of energy consumed to complete the transaction, an infrastructure resource consumption (such as compute resources, storage resources, and networking resources used for the transaction), a proximity of infrastructure devices to the requesting device, a monetary cost and fees associated with the transaction, and the like. Other transaction parameters may also be obtained and considered during the optimization technique.

In general, the transaction management service facilitates an exchange or conversion of one or more assets to one or more other assets over the cloudless infrastructure. The transaction management service may be executed by one or more of the nodes of the infrastructure and made available to personal devices connected to or in communication with the infrastructure. Using the environment 100 of FIG. 1 as an example, the transaction management service may be stored and executed on any of Nodes A-H 110-124 such that the computing devices in communication with the infrastructure (such as device 106 or devices 126-128) may utilize the transaction management service as made available by the nodes. In some implementations, portions of the transaction management service may be stored in multiple nodes of the infrastructure, each of which may be available in combination to the computing devices in communication with the nodes to receive the transaction management service. Further still, portions or all of the transaction management service may be stored on and/or executed by a personal computing device 106 upon registration and verification of the personal device with one or more nodes of the cloudless infrastructure 100.

In some implementations, the transaction management service may utilize one or more other services of the cloudless infrastructure to facilitate or aid in the asset transfer or exchange. For example, the transaction management service may utilize an asset management service or digital wallet associated with a user or device of the infrastructure to determine available assets for exchange when initiated by the user or the device. The asset management service may reside in whole or in parts in nodes of the infrastructure and may maintain, among other information and data, identifiers of an entity associated with the service or assets, identifiers of computing devices associated with the identified entity, information and data of assets associated with the identified entity, and the like. The transaction management service may also utilize one or more security services of the infrastructure to provide a secure exchange of assets. For example, the transaction management service may utilize security service 422 of FIG. 4 to verify or authenticate an identifier of a computing device 106 or user provided to the transaction management service as part of an asset exchange. Similarly, the transaction management service may communicate with security application 406 executed on a computing device 106 to receive one or more secure identifiers of the device and/or a user of the device. For example, the security application 406 executed on the computing device 106 may provide a unique device identifier to the transaction management service to identify the device or a user associated with the device. The transaction management service may utilize the device identifier to access an asset management service to determine one or more assets associated with the identifier. In this manner, the transaction management service may determine available assets of a requesting user in a secure manner. Other procedures of the transaction management service in relation to other services associated with the cloudless infrastructure are discussed below.

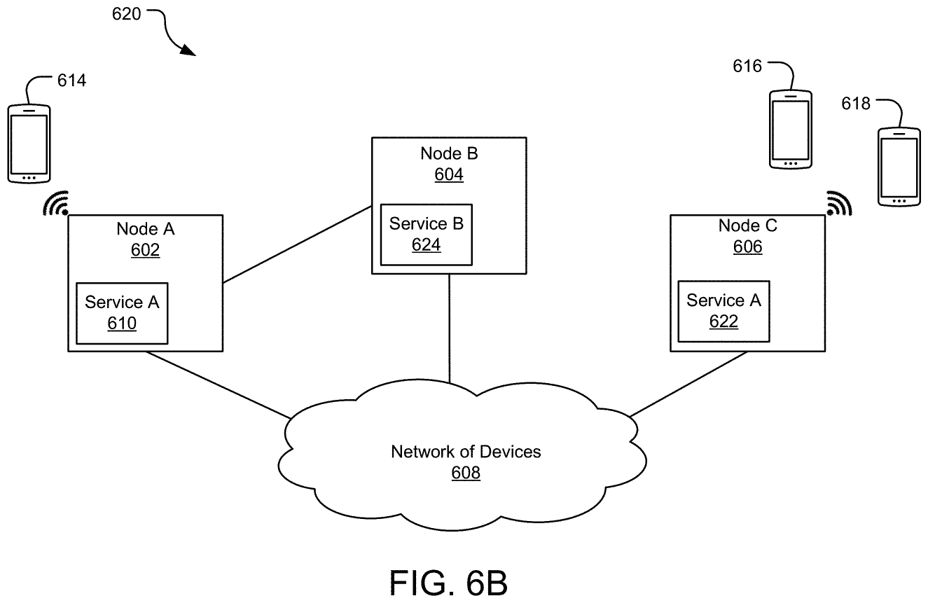

In one particular use, the transaction management service may be utilized to facilitate a purchase of a good or a payment for services. For example, a computing device, such as personal device 126 of FIG. 1, may utilize the transaction management service to purchase groceries or other goods from a grocery store. At a point of purchase, the computing device 126 may execute, using a processing device, a program that communicates with the transaction management service hosted by a node or nodes of the infrastructure, such as node A 110 of the infrastructure 100 of FIG. 1. In response to the request, the transaction management service hosted by the node may perform or execute one or more of the operations of the method illustrated in FIG. 7. More particularly, FIG. 7 is a flowchart of a method 700 for managing a transaction over a cloudless infrastructure 100 of computing devices in accordance with one embodiment. As mentioned above, the transaction management service may be hosted or instantiated on one or more of the nodes or devices of the infrastructure 100. Thus, the operations of the method 700 may be executed through one or more hardware components of nodes or devices of the infrastructure 100 or through one or more programs distributed on the devices of the infrastructure. Further, the operations of the method 700 may be executed in response to a request from a computing device in communication with a node device of the cloudless infrastructure network, such as to purchase goods and services or to exchange one asset for another. Additional uses for the transaction management service are described in more detail below.

Beginning in operation 702, the transaction management service may receive a request, from a requesting device (e.g., computing device 126), to conduct an asset transaction on the cloudless infrastructure 100. In one implementation, the requesting device may be a computing device 126 operated by a user or in response to inputs provided by a user. For example, the computing device 126 may be a smart phone through which the user accesses an application to communicate with the transaction management service, such as during the purchase of goods or services. In response to one or more inputs to the computing device received via an input device, the device 126 may transmit a request to the transaction management service to begin a transaction. In response, the transaction management service may generate and associate, also in operation 702, a unique hash value for the requested transaction. The hash value may be appended or included with all communications between devices to identify and secure the transaction. The unique hash value may include, but is not limited to, a unique identifier of the computing device from which the request is received such that the communications associated with the transaction are secure to the requesting device.

In operation 704, the transaction management service may request and receive, from the requesting device, an approval for the transaction. In particular, the transaction management service may provide a summary of the requested transaction to the requesting device that instructs an application executed by the requesting device to prompt a user or other controlling entity for a verification of the transaction. The response to the prompt may be transmitted to the transaction management service and may include, in some instances, a request for an input, such as a unique identifier or code of the entity associated with the requesting device. In operation 706 and upon receiving the transaction verification from the requesting device, the transaction management service may request and receive a secure identifier of the requesting device and/or an entity associated with the requesting device from a security application executing on the requesting device. In one implementation, the application providing the secure identifier of the requesting device may be the security application 406 discussed above with relation to FIG. 4. Further, the secure identifier may be generated based on entropic data obtained from multiple sensors of the cloudless infrastructure, as described above with relation to the method 500 of FIG. 5. Through the generation of the encryption data based on entropic data obtained from multiple nodes of the infrastructure, a low-consuming, highly-secure, and unique identifier may be generated. This unique identifier may be used to securely identify the requesting device and/or an entity associated with the requesting device, without personal information being included in the identifier, such that the entity of the requesting device may remain anonymous. These and other advantages may be obtained through the generation and use of the unique identifier in a transaction by the transaction management service.

The transaction management service, in operation 708, may authenticate the received secure identifier with a security service of the infrastructure 100. For example, the transaction management service may compare the received identifier with the security service 422 discussed above with relation to FIG. 4 to authenticate the identifier received from the requesting device. In this manner, the transaction management service may verify the identity of an entity or user associated with the requesting device for a secure asset transaction. If the transaction management service determines, in operation 710, that the secure identifier is not authenticated, the transaction may be canceled in operation 712. However, if the secure identifier, and thereby the identity of the entity or requesting device, is authenticated, the transaction management service may determine available assets for the requested transaction based on assets associated with the requesting device as determined by the asset management service in operation 714. In general, one or more devices of the cloudless infrastructure 100 may host the entirety or a portion of the asset management service, also known as an asset “wallet”. The asset management service may store information and data associated with assets of an entity, such as physical currency balances and values, digital currency balances and values, hybrid assets and values, and the like. The asset management service may associate each of the information and data with a particular individual or entity associated with the infrastructure 100. For example, a requesting device connected to the infrastructure may request and receive asset information associated with a wallet from the asset management service. Such information may include a list of assets, a number of assets, and/or a current value of the listed assets. The service may associate the digital wallet with a unique identifier of the entity or a device and store the data associated with the wallet, such as digital asset information, on the cloudless infrastructure 100. The asset management service may then access and provide the information stored in the digital wallet to the requesting device upon receiving a request and verifying the unique identifier is associated with the wallet.

Returning to operation 714, the transaction management service may verify one or more available assets for a requested transaction from the digital wallet associated with the received unique identifier. In some instances, the request for the transaction may include an indicator of a particular asset for the transaction, such as a particular digital or a fiat currency. The transaction management service may, in such circumstances, verify the identified asset is available from the digital wallet associated with the entity or requesting device and has a value that is needed for the requested transaction. Upon verification, the transaction management service may complete the requested asset transfer in operation 716 and notify the requesting device of the completed status of the asset transfer. In one example, the asset transfer may include the transaction management service instructing the asset management service to transfer assets from the digital wallet directly to a receiving entity identified in the transaction request. For example, the transaction management service may communicate with an asset service associated with a receiving entity or device to which the assets are to be transferred. The transaction management service may negotiate with the asset service of the receiving device to initiate the transfer of the asset to the receiving device or asset service. This transfer may include one or more communications with the receiving device to facilitate the transfer of the identified assets. For example, the receiving device may be an asset management server of a grocery store and, upon receiving and verification of the assets from the wallet of the computing device as a user is attempting to buy groceries from the grocery store, may approve the user's purchase with the transferred asset.

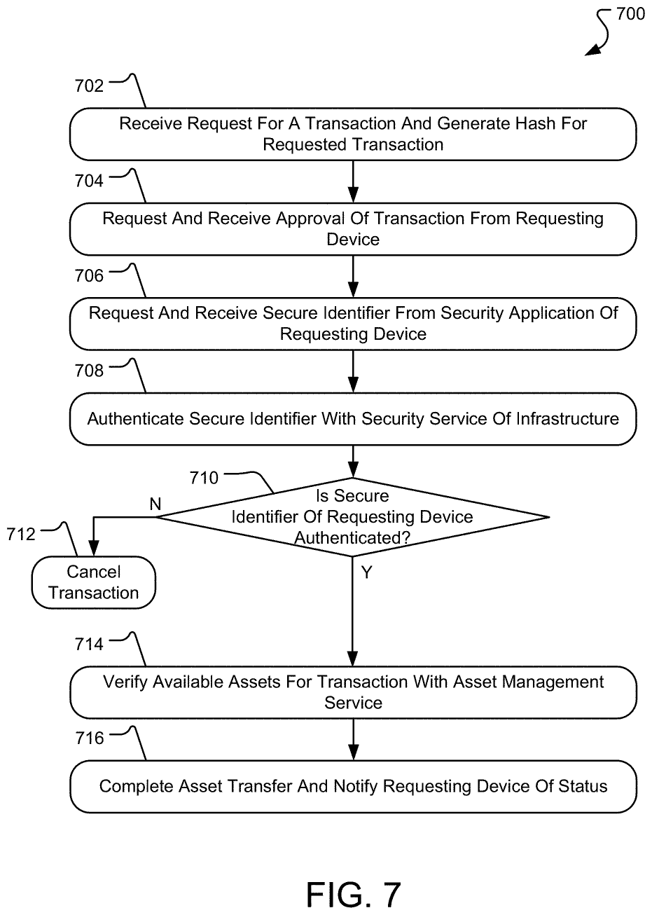

In another example, the asset transfer may include exchanging or converting an asset from the digital wallet to one or more other assets. Such conversions of an asset may optimize one or more transaction parameters, as explained in more detail below with reference to FIG. 8. Regardless of the type of transaction, the transaction management service may not only notify the requesting device of the completed transfer, but may also notify one or more other entities, such as the receiving entity, a transaction monitoring entity, one or more financial institutions, and/or any other entity associated with the requested asset transaction. Thus, through the method 700 of FIG. 7, the transaction management service may facilitate the transfer of an asset associated with a user or device of the cloudless infrastructure to another entity.

As mentioned, in addition to a direct transfer of assets from one entity to another, the transaction management service may also facilitate conversion of one asset to another or multiple other assets as part of the requested transaction. For example, the requested transaction may indicate that a user requests to transfer a first type of digital currency to the receiving entity. However, the receiving entity may not accept the first type of digital currency and may instead only accept a particular physical or fiat currency, such as United States Dollars. In such circumstances, the transaction management service may perform a recursive function to convert an available asset into one or more other assets to complete the transaction, ultimately converting an identified asset to one that is accepted by the receiving device or entity. FIG. 8 is a flowchart of such a recursive method 800 for managing an asset transaction on a cloudless infrastructure 100 of computing devices in accordance with one embodiment. In one implementation, the operations of the method 800 may be executed by the transaction management service as part of operation 716 described above to complete an asset transfer transaction.

Beginning in operation 802, the transaction management service may receive a request for an asset transaction over the cloudless infrastructure, as explained above. The request may include an indication of a target asset or assets that is receivable by the receiving entity for the transaction. For example, the receiving device or entity may only accept fiat assets, such as the U.S. Dollar or other nationally recognized currency. In other instances, the transaction management service may identify an asset that is accepted by the receiving device. For example, the request for the transaction may include an identifier of the receiving device or entity. The transaction management service may then identify which assets the receiving entity accepts. The transaction management service may then query the receiving entity and receive an identification of accepted assets. In another example, the acceptable assets may be stored in a memory accessible by the requesting device or the transaction management service and obtained or otherwise determined to identify the target asset. In operation 804, the transaction management service may verify an identification of the requesting device and/or entity associated with the requesting device, as also described above with relation to the method 700 of FIG. 7. The identification of the requesting device and/or entity may be generated from the entropic data of multiple nodes of the infrastructure, as discussed.

In operation 806, the transaction management service may select an available asset from the asset management service associated with the requesting device or entity. The asset management service may facilitate and manage a digital wallet of assets for the entity and/or requesting device, as described above. Selection of the available asset may be a random selection of a first asset from the digital wallet, such as a digital currency, a physical currency, or a hybrid asset comprising both digital portions and physical portions. In general, any form of asset that has value may be indicated within the digital wallet of the asset management service and selected as the available asset. In some implementations, the request for the transfer may include an indication of a preferred available asset to exchange. For example, the request may include an identifier of a particular asset that is to be selected as the initial asset for conversion. If the digital wallet does not include the identified asset or the identified asset is otherwise not available for conversion or exchanging, the transaction management service may instead select another asset from the digital wallet.

In general, any asset indicated in the digital wallet by the asset management service may be selected as the available asset for use in the transaction. In some instances, the transaction management service may determine a value associated with each asset of the digital wallet to select the available asset. For example, assets in the wallet that do not meet or exceed a particular amount, such as the intended monetary value of the transaction to be transferred to the receiving party, may not be selected as the available asset. To determine the relative value of each asset identified in the digital wallet, the transaction management service or the asset management service of the cloudless infrastructure 100 may communicate with one or more third-party entities and obtain a current or recent value of the assets. For example, the services may contact a financial institution, a trading market or other asset reporting entity, another service hosted by the infrastructure 100 configured to provide a marketplace for one or more assets, or any other asset-related entity to determine a current value of assets relative to other assets. In some instances, current or recent asset values may be stored or maintained by the digital wallet or the asset management service and used to determine a value of the assets identified in the wallet. The transaction management service may utilize the asset value information for each asset in the digital wallet to select an available initial asset for converting or exchanging during the requested transaction.

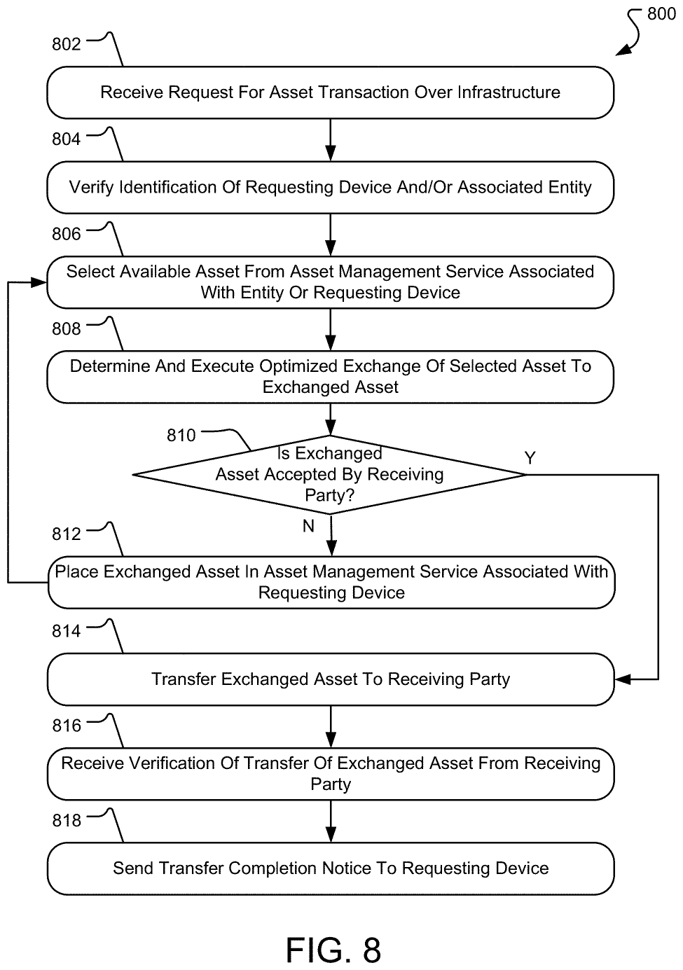

In operation 808, the transaction management service may determine an optimized transfer of the available asset to an exchanged asset. In one particular instance, the transaction management service may determine or calculate a “cost” for exchanging the selected asset with one or more other assets or converting the selected asset to some amount of one or more other assets. The cost for exchanging or converting the selected asset may be based on one or more transaction parameters, including but not limited to, a time to process, an amount of energy consumed to complete the transaction, an infrastructure resource consumption (such as compute resources, storage resources, and networking resources used for the transaction), a proximity of infrastructure devices to the requesting device, a monetary cost and fees associated with the transaction, and the like. One particular optimization technique is described in greater detail below with reference to the method 900 of FIG. 9. Based on the optimization technique, the initial asset may be determined and exchanged or converted to another asset or assets of equal or similar value.

In operation 810, the transaction management service may determine if the exchanged asset (the asset or assets to which the selected or initial asset has been exchanged or converted) is accepted by the receiving party or entity identified in the transaction request. For example and as described above, the receiving entity or device may not accept some types of digital currency or other assets as payment. Rather, the receiving device may be associated with an approved list of assets of which payment for a good or service may be made. In some instances, the exchanged asset may not, therefore, be accepted by the receiving entity. If the exchanged asset is not accepted by the receiving entity, the transaction management service may, in operation 812, place the exchanged asset into the digital wallet associated with the computing device or entity associated with the transaction request. In one implementation, the transaction management service may provide the exchanged asset to the asset management service to inclusion in the entity's digital wallet. In this manner, the initial asset may be exchanged into a different asset of equal value and stored in the wallet associated with the requesting device.

Following the placement of the exchanged asset into the digital wallet, the transaction management service may return to operation 806 in which a new asset from the asset management service associated with the entity or requesting device may be selected. The new asset may be the exchanged asset just entered into the digital wallet or may be another asset indicated by the wallet as being associated with the requesting device. With the asset selected, the transaction management service may execute another round of an optimized exchange of assets and determine if the receiving entity accepts the exchanged asset obtained through this round of asset exchange. In this manner, the asset exchange procedure may be recursive in that available assets may be exchanged for other assets in an optimized manner any number of times until an asset accepted by the receiving device is obtained from the recursive method. Such exchanged assets may include more than one asset such that conversion of an asset may involve receiving a plurality of types of assets in exchange for one type of asset. Further, some implementations of the method may include mechanisms to optimize the recursion process. For example, the method 800 may include a mechanism or technique to prevent exchanging assets back into an asset that has already been previously selected during a current recursive process, to provide an upper limit on the number of recursions or exchanges performed through the method, to provide an upper limit on an amount of time to perform the method, and the like. In general, failure of the recursive method 800 to find an asset acceptable to the receiving entity or device may result in a cancelation of the requested transaction and a return of the initially selected asset or the last exchanged asset to the asset management service and digital wallet.

If an exchanged asset obtained through the recursion technique is identified as acceptable by the receiving party, the transaction management service may, in operation 814, transfer the exchanged asset to the receiving device or entity associated with the transaction. A verification of the received asset may then be received in operation 816 from the receiving device or entity and a notice of completion of the requested transaction may be transmitted to the requesting device in operation 818 from the transaction management service. Thus, through the recursive method 800 of FIG. 8, the transaction management service may facilitate the transaction of an asset to a receiving entity, including converting an initial selected asset into an asset acceptable by the receiving entity.

As mentioned above, the transaction management service may exchange or convert a selected asset through an optimized technique that determines a lowest cost or converting the selected asset to another type of asset. Although discussed herein as a lowest cost, it should be appreciated that the term “cost” may not strictly refer to a monetary value but may instead or also refer to any number of transaction parameters, as explained in more detail below. In one particular implementation, the transaction management service may execute the method 900 of FIG. 9 to optimize a transfer of assets in a cloudless infrastructure of computing devices in accordance with one embodiment. In some implementations, the operations of the method 900 may be executed or performed by the transaction management service, perhaps as a portion of operation 808 of the method 800 of FIG. 8 to optimize a transaction or exchange of one asset type to another asset type.

Beginning in operation 902, the transaction management service may access one or more asset exchange services associated with or in communication with the cloudless infrastructure 100. For example, the transaction management service may access a financial institution, a trading market or other asset reporting entity, another service hosted by the infrastructure 100 configured to provide a marketplace for one or more assets, or any other asset-related entity to determine a current value of a first type of asset relative to other types of assets. The asset exchange service may, in operation 904, determine any exchange agreements for assets included in the asset management service and/or the digital wallet associated with the transaction request. In particular, exchange values for assets may fluctuate over time, with those fluctuations being tracked by the various exchange agreements available from the asset exchange service. For example, a current exchange rate for converting a digital currency to a physical currency may be tracked and made available through an exchange agreement. The asset exchange service may access the one or more exchange agreements to determine the various exchange rates for converting a first asset to one or more other asset types. In general, the exchange agreements may include an indication of a current exchange rate from any known type of asset to any other known type of asset, when made available to the asset exchange service. The asset exchange service may access particular exchange agreements based on the assets associated with a digital wallet associated with the requested transaction. For example, a digital wallet may include a first value in a digital currency type of asset and a second value in a hybrid type of asset. In such an example, the asset exchange service may obtain exchange agreements or other information for converting the digital currency and the hybrid asset into other types of assets, such as physical or fiat assets, other digital currency, and/or other hybrid asset types. Such information may be obtained from any digital market, financial institution, trading platform, and the like and made available through the exchange agreements corresponding to the assets to be exchanged.

In operation 906, the transaction management service may calculate various transaction parameters for converting a selected type of asset to a plurality of other types of assets based on the obtained exchange agreements. In general, the transaction parameters for the conversion may include any measurable component of the exchange or conversion of an asset to another asset. For example, the transaction management service may determine a total time needed to convert the first type of asset to another asset. As completion time may vary based on the exchange agreements and/or the services, converting an asset to another asset may require more time or less time relative to other conversions. In another example, the transaction parameter may calculate a density value of one or more devices of the infrastructure 100 associated with the conversion. For example and as described above, some computing devices of the cloudless infrastructure may provide some or all services to a requesting device. A density value associated with the computing devices used to provide the service to the requesting device may be determined. The density value may include, but is not limited to, such parameters as the consumption of network speed, processing capabilities, storage capabilities, and the like to complete the transaction utilizing the computing device. In still another example, the transaction management service may calculate or determine an amount of energy consumed by the one or more computing devices included in the processing of the asset exchange. Other parameters may also be considered, including but not limited to, a monetary exchange rate for the asset exchange, a consumption of infrastructure bandwidth, whether the exchange is reversible, and the like.

In addition, some parameters may be given a higher weight than others when being compared to determine the least cost for a transaction. For example, the time required to complete the exchange of assets may be given the highest weight, while monetary cost to an entity of the requesting device may be given the lowest weight. In general, the weights applied to any parameter may be configurable by the transaction management service to favor some parameters over others. For example, some transactions, such as the purchase of a good or service, may benefit from a fast conversion of a first asset to an asset accepted by the receiving device to prevent an entity associated with the requesting device to wait until an optimized transaction is complete. In such circumstances, the time to process parameter of an exchange may be given the highest weight when comparing the exchange parameters. In another example, it may be beneficial to minimize the number and monetary cost of the exchanges of assets, such as for a conversion of large amounts of an asset to another asset. In this circumstance, the monetary cost of an exchange may be given the highest weight, while a time to process parameter may be given a low to none weighted value. Further, the weights applied to the transaction parameters may be adjustable through one or more inputs provided to the requesting device. Through an input device, a user or entity of the requesting device may select weights or transaction parameters that are most important such that the applied weighting values to the parameters may be adjustable by a user of the requesting device. In other examples, the transaction management service may automatically select the weights applied to the transaction parameters independent or in conjunction with an input received at the requesting device.

In operation 908, the transaction management service may compare the determined transaction parameters of converting the selected asset to a plurality of other types of assets to determine a “least cost” conversion. As explained above, the cost associated with any exchange may be based on any parameter and may not necessarily be a monetary parameter. For example, the transaction management service may determine which asset exchange may occur the fastest in comparison to the other asset exchanges. In another example, the transaction management service may determine which asset exchange consumes the least amount of energy or satisfies a density threshold. Further, some implementations may include a balancing of multiple parameters to determine the lowest cost, with each parameter including a weighted value or not. In general, the lowest cost calculation may include any number of transaction parameters in any combination. The configuration of transaction parameters may be set by the transaction management service and/or may be configurable by an entity of the requesting device, the requesting device itself, or an administrator of the cloudless infrastructure.

In operation 910, the transaction management service may convert the selected type of asset to a secondary type of asset based on the calculated and compared transaction parameters discussed above. For example, the transaction management service may determine that conversion of the selected asset to the secondary asset would provide the least cost based on the calculated transaction parameters, such as fastest time to completion or least amount of energy consumed. In some implementations, conversion of the selected asset to the secondary asset may include selling the asset at a set price as measured in the secondary asset, renting the asset for a length of time equal to a particular set value, lending the asset for a set time, trading the selected asset directly for the secondary asset, any combination of the above, and the like. Each of the conversions may be made on a proportional level such that some of the selected asset may be converted or exchanged for some of the secondary asset. In general, the conversion of the selected asset to the secondary asset includes exchanging an equal value of the assets such that the transaction management service receives the value of the selected asset in terms of the secondary asset.

In operation 912, the transaction management service may receive verification of the conversion of the selected asset to the secondary asset. In some instances, the verification may be received from a third-party entity through which the conversion is executed. For example, a digital asset may be converted to a physical asset via a third-party exchange website. Upon completion of the conversion, a verification may be provided by the third-party exchange to the transaction management service. In another example, the conversion may occur over a marketplace service hosted by the cloudless infrastructure. A notification of the conversion of the selected asset on the marketplace service may be provided to the transaction management service to complete the conversion. After receiving the verification, the secondary asset may be returned to the transaction management service for inclusion in the asset management service or digital wallet associated with the user of the requesting device, as explained above.

Through the systems and methods described herein, an asset conversion or exchange may occur over the cloudless infrastructure of computing devices. In one particular implementation, the asset selected for conversion and/or the asset to which the selected asset is converted may be a hybrid asset. In general, a hybrid asset includes both a physical component and a digital component in which the value of the asset is dependent on the combination of the components. One example of a hybrid asset is a digital illustration created by an artist that is displayable only on a specific display device. The display device may comprise the physical component of the hybrid asset and the digital illustration may comprise the digital component of the hybrid asset. Taken alone, neither the display device nor the digital component may operate such that the illustration is viewable. Rather, only the combination of the digital illustration and that particular display device may cause the illustration to the viewed. In this manner, the combination of the physical component and the digital component in tandem is considered the hybrid asset. In one particular implementation, the digital illustration may be encrypted such that is it decrypted and displayed only by the specific display device. Similarly, the display device may be configured such that only the digital illustration may be displayed on the device. The value of the hybrid asset may therefore be based on the uniqueness of the hybrid asset, which is enforced through the exclusiveness of the combined components. Other examples of a hybrid asset may include a piece of clothing or other wearable device of which the appearance may be altered based on a software component. The appearance of the clothing may therefore be created by an artist as a digital component and uploaded to the wearable device for display and on which the digital component may be limited to display on only the specific wearable device. It is the uniqueness of the combined physical component and the software component that may provide the hybrid asset a perceived value such that the hybrid asset may be exchanged and/or converted through the transaction management service of the cloudless infrastructure as described above.

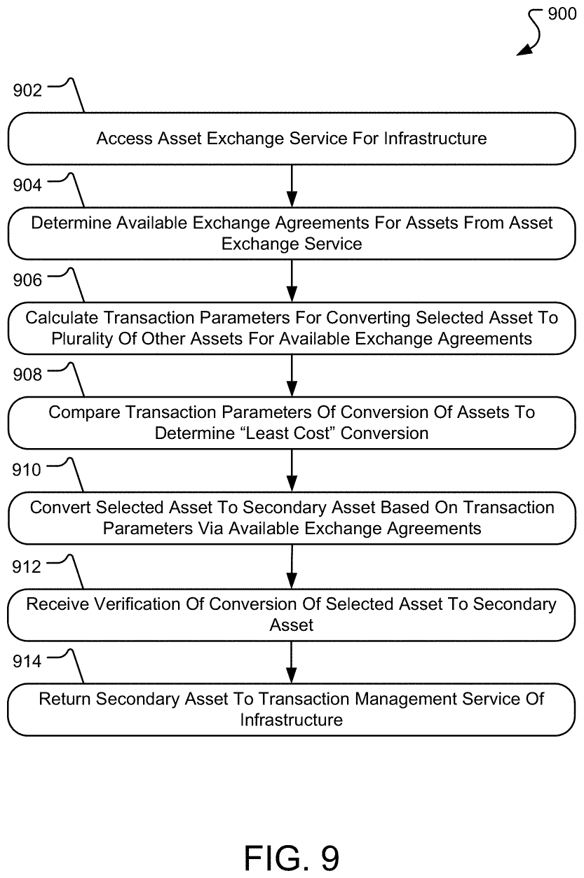

FIG. 10 is a schematic diagram illustrating a general hybrid asset 1006 that includes a physical component 1002 and a software component 1004 in accordance with one embodiment. The physical component 1002 may be any physical device that is alterable through an execution of the software component 1004. Some examples of the physical component may include a framed display, an outer surface of a movable object (such as a car, clothing, a smart phone casing, a lamp, etc.), an inner surface of an object (such as an interior or cab of a vehicle), an inner or outer surface of a structure, such as the interior of a room or an outer wall of the structure, etc. The physical component may include or otherwise be in communication with a computing device and/or a processing component for execution of the software component 1004 of the hybrid asset 1006. In general, any surface or object alterable through the execution of the software component 1004 may be considered the hardware component 1002 of the hybrid asset 1006. The software component 1004 of the hybrid asset may include any program, code, instructions, etc. that alter the appearance or structure of the physical component. For example, the physical component 1002 may include a statue or other device that includes a least on moveable part. The software component 1004 may, upon execution, cause the at least one moveable part to be oriented into a particular position to alter the structure of the physical component 1002. In another example, the software component 1004 may cause an outer surface of a vehicle to cycle through various colors and appearances. To alter the appearance and/or structure of the physical component 1002, the software component 1004 may be executed by the computing device or processing device associated with the physical component. In this manner, the hybrid asset 1006 is formed as a combination of the physical component 1002 and the software component 1004, as illustrated in FIG. 10.

In some instances, the physical component 1002 and the software component 1004 may each be associated with a unique identifier. For example, a unique identifier value, such as one of a pair of encryption keys, may be stored in a memory device of the physical component 1002 and used to identify the physical component to software executed by the software component. The software component 1004 may include a similar encryption key or other unique identifier corresponding to the encryption key stored by the physical component. To combine the physical component 1002 and the software component 1004 in the hybrid asset 1006, the software component may be programmed to obtain and authenticate the unique identifier of the physical component. If the unique identifier is not authenticated, the software component 1004 may not be executed on the physical component. In this manner, the software component 1004 may be programmed or configured to only execute on a physical component 1002 that includes the unique identifier. In some instances, the unique identifier of the physical component 1002 and/or the software component 1004 may be stored and managed in a digital ledger, such as a blockchain. Other information associated with the hybrid asset 1006 may also be stored and managed in the digital ledger, such as identification of ownership of the hybrid asset, login and password information for accessing the physical component 1002 and/or the software component 1004, transaction histories of the hybrid asset, and the like.

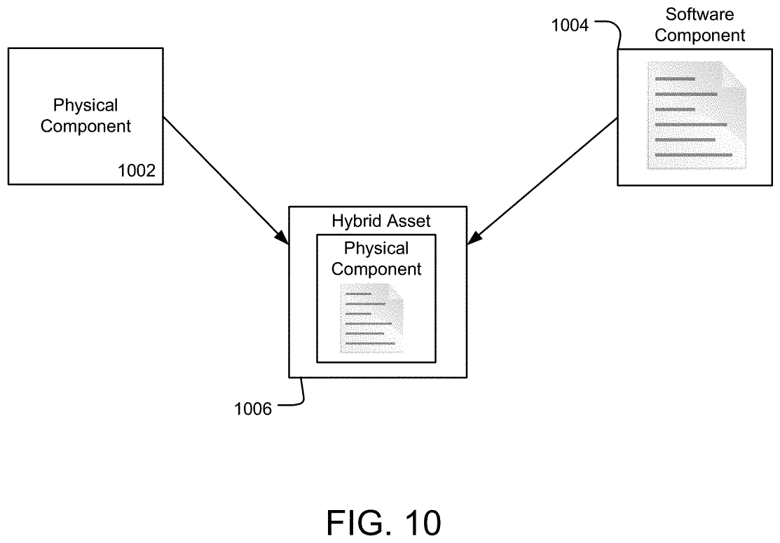

Some implementations of a hybrid asset may include a dynamic component such that one or more characteristics or settings may be automatically altered based on hybrid asset preferences, determined conditions, or changes in conditions associated with the hybrid asset, such as a digital and/or physical condition of the asset, an environment around the hybrid asset, a change in a condition or state of the asset, and the like. The dynamic nature of the hybrid asset may generate an ephemeral unique experience that only the dynamic hybrid asset can provide. For example, a color of the outer surface of a vehicle may be altered based on an identity of a driver of the vehicle, a location of the vehicle, a time of day, the temperature of the vehicle, etc. In general, any aspect or characteristic of the hybrid asset may be altered based on the determined condition, including ceasing operation of the asset, adapting, changing, or evolving of the asset, unlocking hidden features of the asset, and the like. Further, alteration of the hybrid asset may be based on one or more user or device preferences in response to the determined condition, including a series of alterations that may occur in response to one or many determined conditions. FIG. 11 is a flowchart of one method 1100 for altering a characteristic of a dynamic hybrid asset based on one or more preferences and a determined condition in accordance with one embodiment. In some instance, the operations of the method 1100 may be executed by the processing device associated with the hybrid asset based on instructions from the software component 1004 of the asset, although other computing devices may also perform the operations.

Beginning in operation 1102, the processing device may authenticate the identifiers of the physical component and/or the software component of the hybrid asset. As explained above, the identifiers may be utilized by the processing device to maintain the uniqueness of the hybrid asset such that the identified software may only be displayed on or may control the identified physical component. In operation 1104, the processing device may obtain one or more hybrid asset preferences. In one example, the preferences may be user preferences of an operator or owner of the hybrid asset. Such preferences may be provided to the processing device via one or more input devices in communication with the processing device. In general, the hybrid asset preferences may include one or more rules that identifies a condition or characteristic for the hybrid asset in response to a sensed condition, such as an environmental condition, a physical condition of the hybrid asset, a physical condition of an object near the hybrid asset, a change in a status of the hybrid asset, a change in a digital state of the hybrid asset, and the like. For example, the preference may identify a particular color for an outer surface of a vehicle in response to a measured ambient temperature of 70 degrees Fahrenheit or above. In another example, the preference may identify a particular orientation for a movable component for the hybrid asset in response to a time of day or season of the year. In yet another example, a characteristic of the hybrid asset may be altered in response to a detected presence of another hybrid asset. Each hybrid asset may determine a geolocation of the asset, perhaps through a Global Positioning System (GPS) device, and provide the determined location to the cloudless infrastructure discussed above or to other hybrid assets. In turn, one or more hybrid assets may be altered based on a received geolocation of the hybrid asset and another hybrid asset. In general, any configurable or alterable characteristics of the hybrid asset may be identified in a preference. Further, each or some of the alterable characteristics may be associated with a measurable or determinable condition, including a condition that defines a threshold measurable value for the condition upon which the characteristic of the hybrid asset is altered based on the preference.

In operation 1106, the processing device may receive one or more determinable conditions from a sensor configured to obtain or measure the condition. For example, the GPS device may obtain a geolocation of the physical component 1002 of the hybrid asset. In another example, a temperature sensor may provide an ambient temperature around the physical component. In still other examples, a microphone device may detect a noise level near the physical component, one or more sensors may determine a condition of a user of the hybrid asset, the hybrid asset may receive, and/or either directly or from the cloudless infrastructure an indication of a presence of another hybrid asset. In some instances, information and/or data may be obtained from computing devices of the cloudless infrastructure and used as an input to altering the hybrid asset. Such data may be similar to the random data discussed above in relation to generating security information and keys. In this manner, the alterations made to the hybrid asset may be randomized based on the random data obtained from the cloudless infrastructure. In general, any sensor may be associated with the physical component 1002 to measure any detectable condition that may be utilized by the processing device.

In operation 1108, the processing device of the physical component 1002 may alter a characteristic of the hybrid asset based on the obtained preferences and environmental conditions. The characteristic of the hybrid asset may be any configurable component of the hybrid asset which may be altered based on any single or combination of determined and/or measured conditions. For example, a configurable lamp may be altered based on time of day and/or an ambient temperature measured in the environment surrounding the lamp. In another example, a digital painting may be altered based on a captured image of a viewer of the painting. In general, any single or combination of conditions, including a series of measured conditions occurring in a specific order or pattern, may be measured and used to alter the characteristic of the hybrid asset. In this manner, the hybrid asset may be dynamic in response to any determined or measured environmental condition and one or more preferences for altering the hybrid asset.

In some instances, the hybrid asset may comprise multiple physical components and/or multiple digital components. For example, the hybrid asset may include two or more physical components associated with one or more digital components. In another example, the hybrid asset may include two or more digital components or programs associated with one or more physical components. The altering of the hybrid asset may include changing one, some, or all of the physical components and/or the digital components. Such alteration may also be in response to any detected physical condition and/or digital condition. Any combination of physical components and/or digital components may define the hybrid asset and may be altered based on determined conditions.

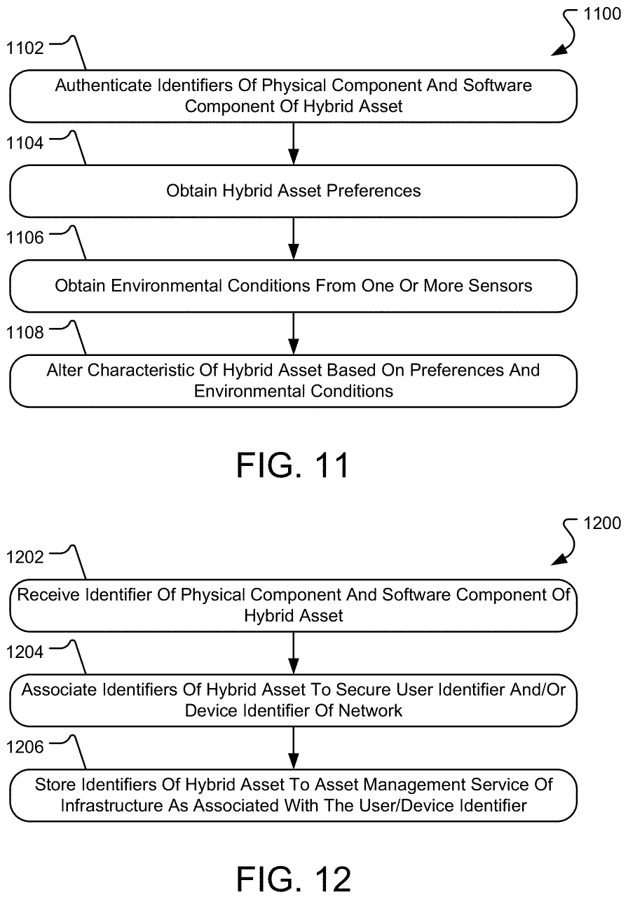

As discussed above, hybrid assets may be one type of asset available to the transaction management service for converting one asset to another. Thus, the hybrid asset may be treated similarly as a digital asset or a physical asset in using the asset to purchase goods or services or to otherwise facilitate some type of payment to a receiving party. FIG. 12 is a flowchart of a method 1200 for associating a hybrid asset with one or more identifiers managed by a cloudless infrastructure of computing devices in accordance with one embodiment. Beginning in operation 1202, a computing device of the cloudless infrastructure may receive an identifier of a physical component 1002 and a software component 1004 of the hybrid asset. The identifiers may be similar to those discussed above such the identifiers may be a unique and encrypted identifier that the physical component 1002 and the software component 1004 may utilize to ensure a unique combination of the components into the hybrid asset 1006. In another implementation, the hybrid asset may include a unique identifier that is provided to the transaction management service.

In operation 1204, the transaction management service may associate the received identifiers of the hybrid asset with a secure user identifier and/or device identifier. As discussed above, a security service of the infrastructure may maintain and/or manage unique identifiers for users and/or devices of the infrastructure. Upon providing the identifiers of the hybrid asset, the transaction management service may associate the hybrid asset with the secure user identifier and/or device identifier. In general, any personal identification information, device identification information, personal data, and/or device data may be used and associated with the hybrid asset. Further, in operation 1206, the transaction management service may store the identifiers of the hybrid asset into an asset management service of the cloudless infrastructure. In one implementation, the hybrid asset identifiers may be stored in a digital wallet service as associated with the user or device identifier. In another implementation, the identifiers may be stored in a cloudless storage file on one or many computing devices of the cloudless infrastructure discussed above. The cloudless infrastructure may also store the one or more digital components of the hybrid asset. In this manner, the hybrid asset may be available as an exchangeable or convertible asset, through the systems and methods described above.

In some implementations, the transaction management service may exchange or convert all or some of the hybrid asset. For example and through the methods described above, the transaction management service may determine a value associated with a hybrid asset available from the asset management service as associated with a user or device. The transaction management service may also provide a digital marketplace through which hybrid assets may be traded, converted, exchanged, etc. The marketplace may also be utilized to rent, license, or lend a hybrid asset. For example, in exchange for a particular monetary value, the hybrid asset may be rented to a third-party entity for which the owner of the hybrid asset may receive the monetary value in some other asset, including another hybrid asset. The renting of the hybrid asset may include, in some instances, a digital contract signed by the selling party and the renting party that stipulates the terms of renting the hybrid asset. The contract may be included in a digital ledger and associated with the hybrid asset. In general, the hybrid asset may be treated as any other type of asset by the transaction management service when converting or exchanging the hybrid asset into another asset. Instances in which ownership of the hybrid asset is sold, the transaction management service may associate the identifiers of the physical component and the software component of the hybrid asset with an identifier of the third-party entity and remove the hybrid asset from the seller's digital wallet.

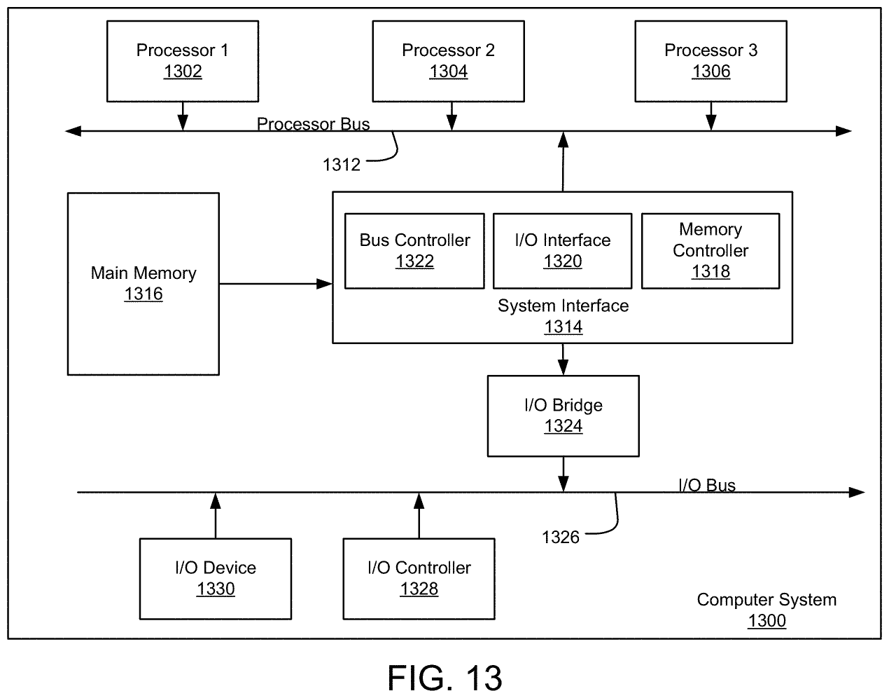

FIG. 13 is a block diagram illustrating an example of a computing device or computer system 1300 which may be used in implementing the embodiments of the components of the network disclosed above. For example, the computing system 1300 of FIG. 13 may be the node device 200 of personal computing device 106 discussed above. The computer system (system) includes one or more processors 1302-1306. Processors 1302-1306 may include one or more internal levels of cache (not shown) and a bus controller or bus interface unit to direct interaction with the processor bus 1312. Processor bus 1312, also known as the host bus or the front side bus, may be used to couple the processors 1302-1306 with the system interface 1314. System interface 1314 may be connected to the processor bus 1312 to interface other components of the system 1300 with the processor bus 1312. For example, system interface 1314 may include a memory controller 1314 for interfacing a main memory 1316 with the processor bus 1312. The main memory 1316 typically includes one or more memory cards and a control circuit (not shown). System interface 1314 may also include an input/output (I/O) interface 1320 to interface one or more I/O bridges or I/O devices with the processor bus 1312. One or more I/O controllers and/or I/O devices may be connected with the I/O bus 1326, such as I/O controller 1328 and I/O device 1330, as illustrated.

I/O device 1330 may also include an input device (not shown), such as an alphanumeric input device, including alphanumeric and other keys for communicating information and/or command selections to the processors 1302-1306. Another type of user input device includes cursor control, such as a mouse, a trackball, or cursor direction keys for communicating direction information and command selections to the processors 1302-1306 and for controlling cursor movement on the display device.

System 1300 may include a dynamic storage device, referred to as main memory 1316, or a random access memory (RAM) or other computer-readable devices coupled to the processor bus 1312 for storing information and instructions to be executed by the processors 1302-1306. Main memory 1316 also may be used for storing temporary variables or other intermediate information during execution of instructions by the processors 1302-1306. System 1300 may include a read only memory (ROM) and/or other static storage device coupled to the processor bus 1312 for storing static information and instructions for the processors 1302-1306. The system set forth in FIG. 13 is but one possible example of a computer system that may employ or be configured in accordance with aspects of the present disclosure.

According to one embodiment, the above techniques may be performed by computer system 1300 in response to processor 1304 executing one or more sequences of one or more instructions contained in main memory 1316. These instructions may be read into main memory 1316 from another machine-readable medium, such as a storage device. Execution of the sequences of instructions contained in main memory 1316 may cause processors 1302-1306 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media and may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices 606 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in main memory 816, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

Embodiments of the present disclosure include various steps, which are described in this specification. The steps may be performed by hardware components or may be embodied in machine-executable instructions, which may be used to cause a general-purpose or special-purpose processor programmed with the instructions to perform the steps. Alternatively, the steps may be performed by a combination of hardware, software and/or firmware.

While the present disclosure has been described with reference to various implementations, it will be understood that these implementations are illustrative and that the scope of the disclosure is not limited to them. Many variations, modifications, additions, and improvements are possible. More generally, implementations in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

Various embodiments of the disclosure are discussed in detail above. While specific implementations are discussed, it should be understood that this is done for illustration purposes only. A person skilled in the relevant art will recognize that other components and configurations may be used without parting from the spirit and scope of the disclosure. Thus, the preceding description and drawings are illustrative and are not to be construed as limiting. Numerous specific details are described to provide a thorough understanding of the disclosure. However, in certain instances, well-known or conventional details are not described in order to avoid obscuring the description.

References to one or an embodiment in the present disclosure can be references to the same embodiment or any embodiment; and, such references mean at least one of the embodiments. Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others.

Various modifications and additions can be made to the exemplary embodiments discussed without departing from the scope of the description. For example, while the embodiments described above refer to particular features, the scope of this invention also includes embodiments having different combinations of features and embodiments that do not include all of the described features. Accordingly, the scope of the present description is intended to embrace all such alternatives, modifications, and variations together with all equivalents thereof.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

1. A method for transaction management in a cloudless infrastructure, the method comprising:
obtaining, via an asset management service hosted on an infrastructure of computing devices, an initial asset associated with a device identifier of a device in communication with the infrastructure;
recursively converting, based on one or more infrastructure performance parameters associated with converting the initial asset to a plurality of other assets, the initial asset to a secondary asset; and
providing access to the secondary asset to a receiving device in communication with the infrastructure.

2. The method of claim 1, wherein the one or more infrastructure performance parameters comprise at least one of a time to completion, an energy consumed, or a density value associated with the computing devices of the infrastructure.

3. The method of claim 2, wherein converting the initial asset to the secondary asset is based on a shortest time to completion.

4. The method of claim 1, wherein recursively converting comprises at least one of exchanging the initial asset with the plurality of other assets, lending the initial asset, licensing the initial asset, or renting the initial asset.

5. The method of claim 1, wherein the initial asset or the secondary asset is at least one of a digital asset, a physical asset, or a hybrid asset, the hybrid asset comprising a physical component and a software component, the software component executable by the physical component based on an authentication of an identifier of the software component and an identifier of the physical component.

6. The method of claim 1, further comprising:
converting the initial asset to a first candidate asset type;
determining the first asset type is not accepted by the receiving device; and
converting, based on the determination, the first candidate asset type to the secondary asset type.

7. The method of claim 1, further comprising:
obtaining, from a computing device of the infrastructure, measurements of an environmental condition associated with the computing device;
generating, based on the measurements of the environmental condition, a device identifier; and
receiving a transaction request comprising the device identifier.

8. The method of claim 7, wherein the measurements of the environmental condition comprise at least one of a temperature, humidity, atmospheric pressure, light, or sound measurements from an environment near the computing device.

9. The method of claim 7, wherein the measurements of the environmental condition comprise a bio-measurement associated with a user of the computing device.

10. The method of claim 7, wherein generating the device identifier comprises translating the measurements of the environmental condition into a sequence of prime numbers, the device identifier comprising the sequence of prime numbers.

11-20. (canceled)

21. A cloudless infrastructure of interconnected computing devices, the infrastructure comprising:
a plurality of node devices, wherein a first of the plurality of node devices comprises a processor and a non-transitory computer-readable medium storing instructions that, when executed, cause the processor of the first of the plurality of node devices to:
obtain, via an asset management service hosted on the infrastructure, an initial asset associated with a device identifier of a device in communication with the first of the plurality of node devices;
recursively convert, based on one or more infrastructure performance parameters associated with converting the initial asset to a plurality of other assets, the initial asset to a secondary asset; and
provide access to the secondary asset to a receiving device in communication with the infrastructure.

22. The cloudless infrastructure of claim 21, wherein the one or more infrastructure performance parameters comprise at least one of a time to completion, an energy consumed, or a density value associated with the computing devices of the infrastructure.

23. The cloudless infrastructure of claim 22, wherein converting the initial asset to the secondary asset is based on a shortest time to completion.

24. The cloudless infrastructure of claim 21, wherein recursively converting comprises at least one of exchanging the initial asset with the plurality of other assets, lending the initial asset, licensing the initial asset, or renting the initial asset.

25. The cloudless infrastructure of claim 21, wherein the initial asset or the secondary asset is at least one of a digital asset, a physical asset, or a hybrid asset, the hybrid asset comprising a physical component and a software component, the software component executable by the physical component based on an authentication of an identifier of the software component and an identifier of the physical component.

26. The cloudless infrastructure of claim 21, wherein the instructions further cause the processor of the first of the plurality of node devices to:
convert the initial asset to a first candidate asset type;
determine the first asset type is not accepted by the receiving device; and
convert, based on the determination, the first candidate asset type to the secondary asset type.

27. The cloudless infrastructure of claim 21, wherein the instructions further cause the processor of the first of the plurality of node devices to:
obtain, from a computing device of the infrastructure, measurements of an environmental condition associated with the computing device;
generate, based on the measurements of the environmental condition, a device identifier; and
receive a transaction request comprising the device identifier.

28. The cloudless infrastructure of claim 27, wherein the measurements of the environmental condition comprise at least one of a temperature, humidity, atmospheric pressure, light, or sound measurements from an environment near the computing device.

29. The cloudless infrastructure of claim 27, wherein the measurements of the environmental condition comprise a bio-measurement associated with a user of the computing device.

30. The cloudless infrastructure of claim 27, wherein generating the device identifier comprises translating the measurements of the environmental condition into a sequence of prime numbers, the device identifier comprising the sequence of prime numbers.
